(19) United States
(12) Patent Application Publication
(10) Pub. No.: US 2010/0161383 A1
(43) Pub. Date: Jun. 24, 2010

(54) PROFIT OPTIMIZER

(76) Inventor: Glen Ores Butler, Lebanon, TN (US)

Correspondence Address: JAMES ADDISON BARRY, JR.;J Barry Law Office, 115 N Castle Heights Ave, Suite 204, LEBANON, TN, 37087, US

(21) Appl. No.: 12/624,749

(22) Filed: Nov. 24, 2009

Related U.S. Application Data
(60) Provisional application No. 61/140,155, filed on Dec. 23, 2008.

(51) Int. Cl. G06Q 10/00; G06Q 50/00

(52) U.S. Cl. 705/10; 705/348; 705/301

(57) ABSTRACT

A system and method for analyzing the profitability of a company's products and services and then maximizing that profit is provided. A contribution margin per unit 138 is multiplied times the forecast in units per year 104. The product of this contribution margin per unit 138 times the forecast in units per year 104 is divided by the product of the total capacity hours per standard run 120 quantity and the planned production runs per year 106. The result is the contribution margin per capacity hour 150 which is also defined here as the capacity value analysis 150. The capacity value analysis 150 provides for determining product rationalization, and profitable growth determination, as well as a metric for profit optimization initiatives such as eliminating constraints, customer perceived value, design for manufacturability, reduced production frequency, and reduced setup time.

### CROSS-REFERENCE

This application claims the benefit of U.S. Provisional Application Ser. No. 61/140,155, filed Dec. 23, 2008, titled Profit Optimizer. The present application is related by the same inventor for all applications; Glen Ores Butler. The U.S. Provisional Application Ser. No. 61/140,155, filed Dec. 23, 2008, titled Profit Optimizer is hereby incorporated in its entirety by reference.

### FIELD OF INVENTION

The present invention generally relates to a system and method for financial accounting and more specifically a system and method for analyzing the profitability of a company's products and services and then maximizing that profit.

### BACKGROUND OF INVENTION

There has been a need for a better system and method for analyzing the profitability of a company's products and services and then maximizing that profit.

One system and method used in the past is software that is based on the job shop approach. A customer order is received, a work order is opened, and expenses are applied to the job. When the job is completed, management has the opportunity to look into a “rear view mirror” to evaluate past performance. There are other inherent flaws with the job shop approach, most notably too many transactions having too little value. When multiple processes are required to complete a product, a work order is opened for each incremental process. Although intuitively it may seem necessary to evaluate performance in each process, it is a distraction to the real objectives of improving finished goods throughput and on-time delivery.

The most common quoting approach is to assign cost to processes, including fixed overhead, and to divide by a throughput rate to establish the standard cost. Materials are added, typically with a markup, and the total cost may be marked up by a profit percentage. If a company has excess capacity, the profit percentage is often lowered to be more competitive. In extreme circumstances products may be quoted as incremental business, meaning fixed overhead expenses are excluded from the quote. A common argument is fixed overhead was covered by other products. Managerial accountants recognized that fixed overhead allocations may lead to bad decision-making Although not GAAP compliant, fixed overhead expenses were eliminated from the product cost to determine the Contribution Margin of a product. Contribution margin pays fixed overhead expenses omitted from the product cost, and the excess, if any, drops to the operating income line. Products may be further evaluated based on the contribution margin percentage, known as Contribution Margin Analysis. Products having the highest contribution margin percentage were considered the most lucrative.

### SUMMARY

A method for providing profit optimization of products and services comprises the steps of determining an economical run sequence to minimize setup time; determining a forecast in units per year; determining a number of planned production runs per year; determining a standard run quantity by dividing the forecast in units per year by the number of planned production runs per year; determining a throughput rate at a constraint; determining a production hours by dividing the standard run quantity by the throughput rate of the constraint; determining a setup time in hours per standard run quantity; determining a total capacity hours per standard run quantity by adding the setup time in hours per standard run quantity with the production hours; determining an hourly cost of capacity budget; determining a total variable cost per standard run quantity by multiplying the total capacity hours per standard run quantity times the hourly cost of capacity budget; determining a standard variable cost per unit by dividing the total variable cost per standard run quantity by the standard run quantity; determining a standard material cost per unit; determining a standard direct cost per unit by adding the standard variable cost per unit and the standard material cost per unit; determining expenses paid to a supplier; determining a selling price of a product per unit; determining a net selling price per unit by subtracting the expenses paid to the supplier from the selling price of the product per unit; determining the contribution margin per unit by subtracting the standard direct cost per unit from the net selling price per unit; determining a contribution margin per year by multiplying the contribution margin per unit times the forecast in units per year; and determining a capacity value analysis by dividing the contribution margin per year by the product of the total capacity hours per standard run quantity times the number of planned production runs per year wherein the capacity value analysis aids in determining the maximum profitability of a company's products and services by concentration on the company's products and services that are the most profitable.

The method for providing profit optimization of products and services further including steps to minimize setup time, the economical run sequence, the throughput rate at the constraint, and the setup time in hours per standard run quantity with the additional steps of: determining a process map per finished product; determining a grouping for finished products based on similar processes based on the process map per finished product; determining a layout of equipment and processes to manufacture in a one-piece flow based on the group finished products based on similar processes; determining assignment of finished products to a focus factory for manufacture in a one-piece flow; and determining a standard based on the throughput rate at the constraint by manufacturing in a one-piece flow.

The method for providing profit optimization of products and services wherein after the step of determining a capacity value analysis, the capacity value analysis provides product rationalization with the additional steps of: dividing the products by classifications including: type of industry, customer, geographic location, type of product, and type of raw material; determining an upper capacity value, a lower capacity value, and a mean capacity value for the classification; analyzing each product within the classification; if capacity value is not greater than zero dollars then jettison products with negative capacity value and eliminate the associated fixed overhead expenses; if capacity value is greater than zero dollars and if annual contribution margin is greater than related fixed overhead then continue manufacturing the product; if capacity value is greater than zero dollars, and if the annual contribution margin related fixed overhead is not greater than the related fixed overhead, then increase price to achieve at least min capacity value, and if customer accepted price, continue manufacturing the product; and if capacity value is greater than zero dollars, and if the annual contribution margin is not greater than the related fixed overhead, then increase price to achieve at least minimum capacity value, and if customer did not accept the accepted price, eliminate the associated fixed overhead expenses.

The method for providing profit optimization of products and services wherein after the step of determining a capacity value analysis, the capacity value analysis provides profitable growth with the additional steps of: determining product classifications with highest capacity value; determining target sales and marketing efforts to highest capacity value products; receiving a request for quote for targeted products; increasing capacity value expectation as capacity is consumed; if quote was not awarded repeat steps of determining target sales and marketing efforts through increasing capacity value expectation; and if quote was awarded determining if capacity is available, if capacity is available, manufacturing product with free capacity avoiding capital investments until capacity value exceeds target, and if capacity is not available, increasing prices on lower capacity value products until customer does not accept price, then use free capacity to higher value opportunities and manufacturing product with free capacity minimizing capital investments until capacity value exceeds target.

The method for providing profit optimization of products and services wherein after the step of determining a capacity value analysis, the capacity value analysis provides metric for profit optimization initiatives with the additional steps of: establishing capacity value improvement initiatives by: designing for manufacturability and increasing throughput and reducing scrap, focus process improvement efforts on the constraint and increasing throughput and reducing scrap, improving customer perceived value and converting perceived value and service into higher prices, value engineering into products and converting perceived value and service into higher prices; evaluating initiatives based on change in capacity value; eliminating operating variances that erode contribution margin, reducing fixed overhead spending; increasing EBITDA; and increasing business value by reducing capital employed and debt service.

A system for providing profit optimization of products and services comprising: a memory storage device for storing data wherein data may be stored and retrieved; an input device for receiving entry of data wherein data may be input into the system; a computer processor operationally connected with the input device and the memory storage device for determining capacity value analysis; the input device receives data including: an economical run sequence to minimize setup time; a forecast in units per year; a number of planned production per year; a throughput rate at a constraint; a setup time in hours per standard run quantity; an hourly cost of capacity budget; a standard material cost per unit; expenses paid to a supplier; and a selling price of a product per unit; and the computer processor determines: a standard run quantity by dividing the forecast in units per year by the number of planned production per year; a production hours by dividing the standard run quantity by the throughput rate at the constraint; the total capacity hours per standard run quantity by adding the setup time in hours per standard run quantity with the production hours; a total variable cost per standard run quantity by multiplying the total capacity hours per standard run quantity times the hourly cost of capacity budget; a standard variable cost per unit by dividing the total variable cost per standard run quantity by the standard run quantity; a standard direct cost per unit by adding the standard variable cost per unit and the standard material cost per unit; a net selling price per unit by subtracting the expenses paid to the supplier from the selling price of the product per unit; the contribution margin per unit by subtracting the standard direct cost per unit from the net selling price per unit; a contribution margin per year by multiplying the contribution margin per unit times the forecast in units per year; and the capacity value analysis wherein the contribution margin per year is divided by the product of the total capacity hours per standard run quantity times the number of planned production runs per year; and an output device operationally connected with the computer processor, the output device for providing the capacity value analysis to aid in determining the maximum profitability of the company's products and services that are maximized by concentration on the company's products and services that are the most profitable based on the capacity value analysis.

The system wherein the computer processor further: determines a process map per finished product; determines a grouping for finished products based on similar processes based on the process map per finished product; determines a layout of equipment and processes to manufacture in a one-piece flow based on the group finished products based on similar processes; determines assignment of finished products to a focus factory; and determines a standard based on the throughput rate at the constraint by manufacturing in a one-piece flow that is used for determining the economical run sequence, the throughput rate at the constraint, and the setup time in hours per standard run quantity.

The system wherein: the computer processor provides product rationalization after determining the capacity value analysis by: the input device receives data including: type of industry, customer, geographic location, type of product, and type of raw material; and the computer processor determines: an upper, lower, and mean capacity value for the classification; analyzing each product within the classification; if capacity value is not greater than zero dollars then the output device directs to jettison products with negative capacity value and eliminate the associated fixed overhead expenses; if capacity value is greater than zero dollars and if annual contribution margin is greater than related fixed overhead then the output device directs to continue manufacturing the product; if capacity value is greater than zero dollars, and if the annual contribution margin related fixed overhead is not greater than the related fixed overhead, then the output device directs to increase price to achieve at least min capacity value, and if customer accepted price, to continue manufacturing the product; and if capacity value is greater than zero dollars, and if the annual contribution margin is not greater than the related fixed overhead, then the output device directs to increase price to achieve at least minimum capacity value, and if customer did not accept the accepted price, the output device directs to eliminate the associated fixed overhead expenses.

The system wherein: the system provides profitable growth of the products and services after determining the capacity value analysis by the input device receiving the input of the data of product classifications with highest capacity value; target sales and marketing efforts to highest capacity value products; request for quote for targeted products, increase capacity value expectation as capacity is consumed and the computer processor determines: if quote was not awarded repeat the steps of receiving target highest capacity value products, request for quote, through increase capacity value expectation as capacity is consumed; if quote was awarded determine if capacity is available, and if capacity is available, manufacture product with free capacity minimizing capital investments until capacity value exceeds target, and if capacity is not available, increasing prices on lower capacity value products until customer does not accept price, then use free capacity for higher value opportunities and manufacture product with free capacity minimizing capital investments until capacity value exceeds target.

The system wherein: the system provides metric for profit optimization initiatives by the input device receiving the input of the data of profit optimization improvement initiatives by designing for manufacturability, and increasing throughput and reducing scrap; focus process improvement efforts on the constraint, and increasing throughput and reducing scrap; improving customer perceived value and converting perceived value and service into higher prices; value engineering into products and converting perceived value and service into higher prices; and the computer processor: evaluates initiatives based on change in capacity value, eliminating operating variances, reducing fixed overhead spending, increasing EBITDA, and increasing business value; and the output device provides changes in capacity value, operating variances that erode contribution margin, fixed overhead spending, EBITDA, and capital employed and debt service information.

A computer-readable medium having computer-executable instructions which when executed by a computer system cause the computer processor to perform operations that provide for profit optimization comprising: receiving and storing data comprising: an economical run sequence to minimize setup time; a forecast in units per year; a number of planned production per year; a throughput rate at a constraint; a setup time in hours per standard run quantity; an hourly cost of capacity budget; a standard material cost per unit; expenses paid to a supplier; and a selling price of a product per unit; and determine a capacity value analysis by determining: a standard run quantity by dividing the forecast in units per year by the number of planned production per year; a production hours by dividing the standard run quantity by the throughput rate at the constraint; the total capacity hours per standard run quantity by adding the setup time in hours per standard run quantity with the production hours; a total variable cost per standard run quantity by multiplying the total capacity hours per standard run quantity times the hourly cost of capacity budget; a standard variable cost per unit by dividing the total variable cost per standard run quantity by the standard run quantity; a standard direct cost per unit by adding the standard variable cost per unit and the standard material cost per unit; a net selling price per unit by subtracting the expenses paid to the supplier from the selling price of the product per unit; the contribution margin per unit by subtracting the standard direct cost per unit from the net selling price per unit; a contribution margin per year by multiplying the contribution margin per unit times the forecast in units per year; and the capacity value analysis wherein the contribution margin per year is divided by the product of the total capacity hours per standard run quantity times the number of planned production runs per year wherein the capacity value analysis aids in determining the maximum profitability of a company's products and services by concentration on the company's products and services that are the most profitable.

The computer-readable medium wherein the computer-readable medium further provides computer-executable instructions wherein the capacity value analysis provides product rationalization by the computer processor performing the further steps of: receiving and storing the input of the data of the products by classifications including: type of industry, customer, geographic location, type of product, and type of raw material; determining an upper, lower, and mean capacity value for the classification and analyzing each product within the classification; if the capacity value is not greater than zero dollars then jettison products with negative capacity value and eliminate the associated fixed overhead expenses; if capacity value is greater than zero dollars and if annual contribution margin is greater than related fixed overhead then continue manufacturing the product; if capacity value is greater than zero dollars, and if the annual contribution margin related fixed overhead is not greater than the related fixed overhead, then the output device directs to increase price to achieve at least min capacity value, and if customer accepted price, continue manufacturing the product; and if capacity value is greater than zero dollars, and if the annual contribution margin is not greater than the related fixed overhead, then the output device directs to increase price to achieve at least minimum capacity value, and if customer did not accept the accepted price, the output device directs to eliminate the associated fixed overhead expenses.

The computer-readable medium wherein the computer-readable medium further provides computer-executable instructions wherein the capacity value analysis provides profitable growth by the computer processor performing the further steps of: receiving and storing the input of the data of: target sales and marketing efforts to highest capacity value products; request for quote for targeted products, increase capacity value expectation as capacity is consumed and the computer processor determines: if product was not awarded repeat the steps of receiving the target highest capacity value products; request for quote, through increase capacity value expectation as capacity is consumed; if product was awarded determine if capacity is available, and if capacity is available, manufacture product with free capacity minimizing capital investments until capacity value exceeds target, and if capacity is not available, increasing prices on lower capacity value products until customer does not accept price, then use free capacity for higher value opportunities and manufacture product with free capacity minimizing capital investments until capacity value exceeds target.

The computer-readable medium wherein the computer-readable medium further provides computer-executable instructions wherein the capacity value analysis provides a metric for profit optimization initiatives by the computer processor performing the further steps of: receiving and storing: the input of the data of profit optimization improvement initiatives by designing for manufacturability, and increasing throughput and reducing scrap, focus process improvement efforts on the constraint, and increasing throughput and reducing scrap; improving customer perceived value and converting perceived value and service into higher prices; value engineering into products and converting perceived value and service into higher prices and the computer processor: evaluates initiatives based on change in capacity value, eliminates operating variances, reducing fixed overhead spending, increasing EBITDA, and increasing business value; and the output device provides changes in capacity value, operating variances that erode contribution margin, fixed overhead spending, EBITDA, and capital employed and debt service information.

The computer-readable medium wherein the computer-readable medium further provides computer-executable instructions wherein the computer processor further performs operations comprising: determining a process map per finished product; determining a grouping for finished products based on similar processes based on the process map per finished product; determining a layout of equipment and processes to manufacture in a one-piece flow based on the group finished products based on similar processes; determining assignment of finished products to a focus factory; and determining a standard based on the throughput rate at the constraint by manufacturing in a one-piece flow that is used for determining the economical run sequence, the throughput rate at the constraint, and the setup time in hours per standard run quantity.

### BRIEF DESCRIPTION OF THE DRAWINGS

The features, aspects, and advantages of the invention will become better understood with regard to the following description, appended claims, and accompanying drawings where:

FIGS. 1A and 1B is a flow chart illustrating a series of steps for one embodiment of the profit optimization system;

FIG. 2 is a flow chart illustrating a series of steps that may be used for determining a process map and establishing a product cost standard based on throughput rate @ the constraint for one embodiment of the profit optimization system;

FIG. 3 is a flow chart illustrating a series of steps that may be used for determining product rationalization for one embodiment of the profit optimization system;

FIG. 4 is a flow chart illustrating a series of steps that may be used for determining profitable growth for one embodiment of the profit optimization system;

FIG. 5 is a flow chart illustrating a series of steps that may be used for determining metric for profit optimization initiatives for one embodiment of the profit optimization system;

FIG. 6 is a block diagram depicting an embodiment of the profit optimization system;

FIG. 7 is a graph illustrating eight similar products with related capacity value;

FIG. 8 depicts a focus factory budget with typical time sensitive expenses;

FIG. 9 illustrates a constraint and the effect of changing the constraint;

FIG. 10 illustrates three business units created that focus on three different markets;

FIG. 11 shows a Master Production Schedule where actual customer demand is less than planned capacity with an automatic update to fill shortages;

FIG. 12 depicts a capacity plan with erratic actual customer releases;

FIG. 13 depicts an inventory plan established within one embodiment of a profit optimization system;

FIG. 14 illustrates a normal release, pull quantity, and customer release with an inventory plan;

FIG. 15 illustrates an income statement template where one embodiment of a profit optimization system identifies waste within the operation;

FIG. 16 depicts one embodiment of the profit optimization system spending variances with productivity;

FIG. 17 shows a productivity variance with more parts than standard and the effect;

FIG. 18 depicts the effect of spending and productivity variance with actual contribution margin and standard contribution margin;

FIG. 19 illustrates shrink with one embodiment of the profit optimization system; and

FIG. 20 depicts unfavorable variances and inefficiency with a focus factory.

### DETAILED DESCRIPTION OF THE INVENTION

The present invention relates to the field of a system and method of financial accounting for analyzing the profitability of a company's products and services and then maximizing that profit. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

Definitions: For a method, system, and computer-readable medium:

Economical run sequence: A sequence that is determined before the start of production that minimizes setup time. The master production schedule, which is organized in an economical run sequence, is populated with actual customer releases and/or shortages to an inventory plan. Each finished product assigned to a focus factory may be ranked in an economical run sequence that becomes the template for the master production schedule within the machine/computer system. A focus factory manufactures all similar products providing capacity is available. Customer orders/releases are input to populate the master production schedule. The master production schedule that adheres to the economical run sequence is generated within the computer system based on the following logic: 1) make to customer order shortages that cannot be shipped from inventory, and 2) make to the inventory plan shortages. The automatically generated production schedule can be manually overridden.

Forecast in units per year: Sales projections for a specific product for the following twelve months e.g. Ford may project to sell 200,000 Fusions in 2009. An annual sales forecast in units is input by finished product. The sales forecast is stored in the computer system data base to be used in several calculations including but not limited to; standard run quantity, inventory plans, and capacity plans.

Planned production runs per year: The number of times annually that a product is planned to be manufactured. Planned production runs typically correspond with the lead-time that is committed to the customer e.g. a four week customer lead-time would mean the product would be produced thirteen times per year (52 weeks per year/4 week lead-time)=13 production runs per year. The number of production runs per year is input for each focus factory but can be manually overridden based on a unique agreement made with a specific customer. The production runs per year are denoted within the computer system by selecting daily, weekly, monthly, quarterly, etc. as the frequency that a product would be manufactured. The selection is used in several calculations i.e. standard run quantity, inventory plans, and capacity plans.

Standard run quantity: The forecast in units per year divided by the planned production runs, typically the same as customer lead-time, shipments, and lot size. The standard run quantity is automatically computed within the computer system but can be manually overridden. The computer system retains the standard run quantity so it can be used in several calculations including but not limited to: production hours, capacity planning, and inventory planning.

Throughput rate at the constraint: The slowest process in a manufacturing flow to manufacture a finished product. The constraint dictates the throughput rate. The throughput rate is established by determining the time required to complete each process e.g. a 60 second cycle equates to 60 units per hour (360 seconds per hour/60 seconds per unit)=60 units per hour. Non-constraint processes are all the incremental processes other than the constraint. Non-constraint processes may be combined into a work center so that multiple processes, that supply the constraint, may be performed with fewer people simultaneously. Each process is timed and input into the computer system for each finished product. The computer system automatically calculates the throughput rate based on the slowest cycle. All processes for each finished product are illustrated individually with the slowest, or constraint, being highlighted in red. In order to increase the throughput rate the cycle time of the red process must be reduced.

Production hours: The number of hours at standard that are needed to manufacture the standard run quantity based on dividing the standard run quantity by the throughput rate at the constraint. No further input is necessary to determine the production hours. The computer system calculates the production hours required to manufacture the standard run quantity.

Setup hours per standard run quantity: The time it takes from stopping production of one product to manufacturing conforming parts of the next product in the economical run sequence. The setup hours are assigned to the subsequent product. The standard setup time is established and input. Setup time is stored in the data base in hours and automatically used in several calculations including, but not limited to: capacity planning, standard cost, and production scheduling.

Total capacity hours per standard run quantity: Both setup hours and production hours are included when determining the number of capacity hours required to manufacture a standard run quantity and the contribution margin per capacity hour, or capacity value analysis. No further input is required to determine the total capacity hours per standard run quantity. The computer system calculates the total capacity hours by dividing the standard run quantity by the throughput rate at the constraint to determine production hours, then adding the setup hours. The total capacity hours is used in several calculations including, but not limited to: capacity planning, standard costing, and capacity value analysis.

Hourly cost of capacity budget: Variable spending directly associated with the manufacturing processes that are more time, than production sensitive. Labor, supplies, maintenance and possibly other expenses specific to the industry are considered variable expenses. An hourly budget is established to represent acceptable spending for the combination of processes, or capacity, during the manufacturing process which may also be referred to as a focus factory budget. The budget for cost of capacity is established and input into the computer system for each focus factory. Finished products are assigned to a focus factory. An hourly cost of capacity for each focus factory is stored in the data base to be used in standard product cost calculations.

Total variable cost per standard run quantity: The total variable cost per standard run quantity is determined by multiplying the total capacity hours, production hours and setup hours, per standard run quantity times the hourly cost of capacity budget. No additional input is required other than those previously stated. The computer system determines the total variable cost per standard run quantity.

Standard variable cost per unit: The standard variable cost to manufacture a finished product is determined by dividing the total variable cost per standard run quantity by the standard run quantity. No additional input is required other than those previously stated. The computer system computes the standard variable cost per unit from data stored in the computer system memory.

Standard material cost: The cost of raw materials and purchased parts, based on the standard purchase price of the materials and parts, required to manufacture a single finished product. The bill of materials is the sum of the materials and purchase parts at the standard purchase price that are required to manufacture a finished product. A material item master is a menu of raw materials and purchase parts at standard cost to develop a bill of materials. The item master also includes other important data i.e. minimum purchase quantities, box quantities, and suppliers to mention a few. A bill of materials is developed for each finished product based on the quantities required times the standard delivered cost. The computer system includes an item master that must be developed for each purchased item including purchase parts and raw materials. Some users may include packaging and other materials in the item master. The computer system maintains a perpetual inventory based on raw material receipts, production, and cycle count adjustments.

Standard direct cost per unit: The standard variable cost per unit plus the standard material cost per unit is the standard direct cost per unit. The standard direct cost represents the total manufacturing cost of a finished product and does not include allocated costs that are not directly related to the manufacturing process. Moreover, direct costs could be avoided if a manufacturing process was not scheduled. The standard direct cost per unit requires no input of additional data other than that previously mentioned. The computer system stores the standard direct cost for each finished product to be used for inventory valuation, performance metrics, contribution margin, and capacity value analysis.

Selling price per unit: The quoted customer selling price of a finished product. The target selling price of each finished product may be determined within the computer system however, it may be manually overridden with the actual selling price that was quoted if different. The computer system provides a target selling price based on the mean contribution margin per hour for products that have a higher capacity value than the overall mean. The target selling price is based on a target contribution margin per hour for each focus factory that is believed to be market value. The target selling price can be manually overridden to achieve more, or less, contribution margin per hour.

Supplier paid expenses: Non-manufacturing expenses that are paid by the supplier and that reduce the contribution margin of the finished product. Two typical deductions include commissions and freight. Supplier paid expenses may be input into the computer system and deducted from the selling price. The computer system includes edit fields that are input to achieve a net selling price for contribution margin and capacity value analysis.

Net selling price: The customer selling price less non-manufacturing expenses. There is no additional input of data required for net selling price. The computer system has a selling price which is the customer invoice price of a finished product and the computer system deducts non-manufacturing expense inputs to determine the net selling price.

Contribution margin per unit: The net selling price of a unit less the direct cost per unit is the contribution margin per unit. The direct cost does not include fixed overhead allocations therefore contribution margin pays fixed overhead expenses. There is no additional data input for determining the contribution margin per unit. The computer system deducts all finished product related expenses to determine the contribution margin per unit. The data is stored for other calculations including capacity value analysis.

Contribution margin per year: Contribution margin per unit multiplied by the forecasted units per year determines the contribution margin per year for a particular finished product. There is no additional data input required to determine the contribution margin per year other than those previously mentioned. The computer system determines the contribution margin per year of each finished product.

Contribution margin per capacity hour: Contribution margin per year divided by the product of total capacity hours per standard run quantity and planned production runs per year provides the contribution margin per capacity hour. Capacity should be considered a commodity, or limited resource, therefore it is crucial to maximize the contribution margin that is generated from capacity. Capacity requires a capital investment, justifies fixed overhead spending, and limits the profit potential of a company. No further data input is required to determine the contribution margin per capacity hour other than those previously mentioned. The computer system calculates contribution margin per capacity hour for each finished product and uses the data to determine the market value of processes and target pricing.

Capacity value analysis: Capacity value analysis is the name the inventor has assigned to contribution margin per capacity hour. There are a number of costing/pricing methodologies, any one of which can establish the market price. Capacity value analysis provides a standardized benchmark to evaluate and maximize product profitability. Moreover, using capacity value analysis for pricing enables a company to cherry-pick the opportunities that are most lucrative. Cherry-pick is carefully selecting products that are the most profitable, specifically, pricing to secure opportunities that generate the highest capacity value. Each finished product has a capacity value that is either above, or below the mean, and above, or below the target. The computer system provides numerous reports that are available upon request for making pricing, jettison, and marketing decisions. Each finished product has a capacity value that is stored in the computer system data base. In addition to products, capacity values are assigned to other criteria within the computer system, i.e. capacity values by customer, geographic location, etc that improves the effectiveness of management decisions.

Develop a process map: Manufacturing a finished product requires one, or more, processes. Accordingly, the list of processes required to manufacture a finished product is commonly referred to as a process map. An individual, or individuals, design the most efficient processes to manufacture a finished product. The processes are input into the computer system as a focus factory that would manufacture all similar products providing capacity is available. Within the computer system the user may establish processes that mirror the most efficient manufacturing processes. If not already accomplished, the manufacturing processes should be rearranged to mirror the computer system. Although the computer system retains the information for future use, all aspects of process mapping is input.

Group finished products based on similar processes: Finished products that require the same, or similar, processes can likely be manufactured within the same focus factory if capacity is sufficient. Therefore, each finished product would be assigned to the most appropriate focus factory with other similar products. The user must assign each finished product to the most appropriate focus factory that includes the processes required. As previously stated, the cycle time for each process is also input. The computer system requires that each finished product be assigned to a focus factory before a standard cost and selling price can be established.

Layout equipment and/or processes: Once processes required to manufacture similar products have been identified, an efficient plant layout for each focus factory can be designed. The goal is to group multiple processes into workstations so that the combined cycle times of the processes within a workstation are equal to other processes therefore minimizing headcount. The most efficient layout is designed to manufacture similar products efficiently. The layout should mirror the processes and cycle times that are outlined in the computer system which should influence the configuration of processes.

Manufacture in a one-piece flow: A single part should be transferred from process to process instead of transferring batches of parts. A one-piece manufacturing flow enables the next process to detect a single bad part rather than a batch of bad parts, and the constraint is more easily identified. Manufacturing processes should be configured in reasonable proximity of one another to avoid batching, queuing, and unnecessary transfer expenses. The computer system recognizes work-in-process at material cost only to discourage batch and queue manufacturing. Earned dollars based on standard costs are only recognized when a finished product is manufactured.

Divide products into classifications: Optimizing product profitability requires an ongoing evaluation of what attributes may affect selling prices and capacity values. Accordingly, capacity value analysis may be assigned to a variety of product classifications i.e. type of industry, customer, geographic location, type of product, and type of raw material to name a few. After identifying the more lucrative markets a sales and marketing strategy should be developed to secure new opportunities. The user may establish finished product classifications within the computer system they want to evaluate and track. This enables the user to determine, based on capacity values, the most lucrative finished products. The computer system maintains critical data to run a variety of reports relating to capacity values.

Determine upper, lower and mean capacity value: The range between upper and lower capacity values within a focus factory, or finished product classification, indicates the pricing range within a market segment but could also represent pricing disparities. The mean capacity value, which is a weighted average calculated by dividing the total annual contribution margin by the total annual capacity hours, is perhaps is the best indicator of market pricing. Moreover, the objective is to continually increase the mean capacity value by addressing the products that are below the mean. To increase capacity values and improve profitability the management team must constantly re-evaluate the least lucrative use of capacity. The computer system provides graphs from stored data that illustrate capacity value ranges.

Is capacity value >$0, is capacity value > mean, is contribution margin > related fixed overhead: Products are evaluated based on capacity value and contribution margin. Although a product may generate a positive capacity value and contribution margin, it may be under-priced if similar products have higher capacity value. If price increases result in a loss of business, fixed overhead must be reduced to offset the loss of contribution margin. Fixed overhead expenses have been omitted when calculating contribution margin however, contribution margin should exceed the fixed overhead expenses that would have been allocated. A company must constantly pursue the most contribution margin from the least amount of capacity. This may be accomplished through price adjustments if products seem to be significantly under-priced based on capacity values of similar products. The data is available through a variety of reports.

Jettison products and associated fixed overhead: A company often has a substantial amount of under-contributing products that add complexity to the company. Moreover, complexity justifies additional management and administrative resources. It may be more expedient to jettison products and/or customers so the organization can be right-sized than to issue price increases. In most cases, the expenses that are cut far exceed the contribution margin that is lost from jettisoning. For this particular step, evaluating the data and taking the necessary steps requires human intervention, although the computer system provides the necessary data and reports. All the data needed to make difficult decisions is provided by the computer system with no additional data inputs other than running reports.

Eliminate fixed overhead expenses: All expenses other than those directly assigned to a focus factory that becomes part of the standard finished product cost are considered fixed overhead expenses. These fixed overhead expenses may be assigned to a business unit, administrative support, etc but all remain relatively constant even when sales fluctuate. Fixed overhead expenses are paid from contribution margin that is generated from sales. An ongoing challenge is to simplify operations and reduce fixed overhead. A fixed overhead budget should be established and compared with actual spending. The computer system provides a fixed overhead budget that must be input. Actual spending is charged to the accounts either through the disbursements journal or accounts payable. The profit and loss statement includes a fixed overhead budget, actual spending, and a spending variance to evaluate spending effectively.

Target Sales and Marketing Efforts: It is not uncommon for companies to pursue sales at the expense of contribution margin and capacity value. Identifying the most lucrative opportunities enables a company to focus sales and marketing efforts accordingly, therefore reducing expenses while improving contribution margin. The sales and marketing strategy may be developed by management using the data provided by the computer system. The computer system provides capacity value graphs and reports without additional data inputs.

Request for quote: A request from a customer to determine if the company should be awarded an opportunity. Inasmuch as possible, a request for quote would be the result of targeted sales and marketing efforts. The user must input critical information into the computer system so that a target price can be provided. The target price can be overridden by the user and the capacity value would be adjusted accordingly. The computer system includes a comprehensive quoting package that requires inputting critical information.

Increase capacity value expectation: Capacity is a limited resource, which should increase in value as it is consumed, or depleted. This pricing philosophy is in concert with the “law of supply and demand”, which could be translated “when capacity is consumed it should increase in value”. This approach is in sharp contrast with the incremental pricing philosophy that suggests pricing at lower margins is appropriate once fixed overhead expenses have been covered. The latter approach has at least two significant flaws: 1) lower prices on new business will drive market values down on existing business, and 2) new opportunities at lower margins may not financially justify capital investments for additional capacity. Pricing decisions that support a business strategy must be strictly monitored by management to insure conformance. The computer system provides an ongoing comparison between the original mean capacity value and the current mean capacity value to insure capacity value is continually increasing as capacity is consumed. No additional data must be input.

Free capacity: Free capacity is the difference between total capacity and utilized capacity. Free capacity represents an opportunity to add new business with minimal, or no, capital investment. Free capacity may be valued based on a realistic capacity value, typically the mean. E.G. 2,000 hours of free capacity at a mean capacity value of $100 per hour represents $200,000 in potential contribution margin annually. The computer system provides free capacity by focus factory and the potential annual contribution margin based on the mean capacity value. No additional inputs are required to determine the growth potential of the company.

Capital investment justification: To avoid unnecessary capital investments it is important that the mean capacity value meets/or exceeds the target, and capacity is substantially utilized before making capital investments. Capital investments for process improvements may be justified by cost reductions times the annual volume to determine the annual savings. Capacity value information is provided within the computer system however actual pricing and capital investment decisions must be made based on risk and reward. The computer system provides real time mean capacity values based on the active products within each focus factory and automatically utilizes this information to arrive at suggest pricing for new opportunities.

Capacity value improvement initiatives: Capacity value improvement initiatives focus on increasing throughput (producing more in less time) and increasing the selling price (more contribution margin during the same time). These initiatives improve profitability as well as profit potential as free capacity increases (more capacity for new opportunities) and higher capacity value (free capacity would have higher market value). The change in capacity value quantifies the effectiveness of each improvement initiative. Management must outline the improvement initiatives that will be measured against the standard capacity value. The updated capacity value (after completing the initiative) will be compared to the original standard. Accordingly, improvements in capacity value can be the basis for incentive pay. The computer system archives capacity value history so that each initiative is measured against a new standard. To change the capacity value a new throughput rate, selling price, and/or cost reductions must be input.

Design products for manufacturability: Changing a product design so the function remains the same but it is easier to manufacture is designing for manufacturability. Typically, the benefit of this capacity value improvement initiative is lower cost and higher throughput. Management must outline the new product design and process changes. The updated capacity value (after completing the initiative) will be compared to the original standard. New standards may be input into the computer system. The computer system archives capacity value history so the effectiveness of the new product design can be measured against the original capacity value standard. To change the capacity value a new throughput rate, selling price, and/or cost reductions must be input.

Throughput at the constraint: If more than one process is required to manufacture a finished product, the constraint, or slowest process, determines the throughput rate for product costing and capacity value analysis. Conversely, improving the throughput rate of non-constraint processes will not affect the overall throughput rate, nor is it likely to reduce product cost. A manufacturing initiative should be to continually improve throughput at the process constraint. Management must outline the process changes to improve throughput at the constraint. The updated capacity value (after completing the initiative) will be compared to the original standard. New standards would be input into the computer system. The computer system archives capacity value history so the effects of the higher throughput rate can be measured against the original capacity value standard. To change the capacity value a new throughput rate, selling price, and/or cost reductions must be input.

Value engineering for finished products: In addition to designing products for ease of manufacturing, products may be designed to perform better, or could be a unique design that eliminates the competition. In any case, value engineering equates to a higher selling price, higher margin, and higher capacity value, all of which would be achieved because the product is considered superior. Management must outline the benefits and cost of the value engineered product to determine the capacity value change. The updated capacity value (after completing the initiative) will be compared to the original standard. New standards must be input into the computer system. The computer system archives capacity value history so the effects of the engineering changes can be measured against the original capacity value standard. To change the capacity value a new bill of materials and selling price are likely to require further input.

Improve customer perceived value: As customer relationships improve it is less likely the supplier must have the lowest price. As a result, improved customer perceived value would result in higher margins and a higher capacity value. Seemingly, intangible aspects of the relationship that may overshadow price include superior quality, on-time delivery, and responsiveness beyond customer expectations. The supplier should always listen to what the customer feels is most important and design manufacturing processes and systems to accommodate the expectations. The improved relationship could equate to higher prices and higher capacity values than the competitors. Regardless of the expectation, updated capacity value (after completing the initiative) will be compared to the original standard. New standards must be input into the computer system. The computer system archives capacity value history so the effects of improved customer perceived value can be measured against the original capacity value standard. To change the capacity value only the selling price may need updating.

Eliminate operating variances: Each finished product has a standard cost, contribution margin and capacity value. If manufacturing is inefficient, unfavorable operating variances will increase the product cost and reduce contribution margin and capacity values. It is an ongoing profit optimization initiative to improve operations so that operating variances are favorable rather than unfavorable. A favorable operating variance would reduce product cost and increase contribution margin and capacity values. Quantifying waste, i.e. spending, productivity, and purchase price variances enables management to address the variances therefore increasing profitability. An ongoing objective is to improve manufacturing operations to eliminate variances. The computer system provides detailed variances by focus factory that compares daily spending to budget and actual production to standard on a daily basis by shift. The operating variance summary, by account, is included in the profit and loss statement to quantify the performance impact on profitability.

Increase EBITDA: Earnings before interest, taxes, depreciation and amortization represents free cash before debt service and taxes. EBITDA is commonly considered the most important financial metric to value a company. Specifically, a company may sell based on a multiple of EBITDA, e.g. $3 million in EBITDA times a multiple of 5 would mean the company would sell for $15 million less the debt. The inventor's objective is to increase EBITDA while reducing the debt to optimize shareholder value. Increasing EBITDA and shareholder value should be a primary concern of any company. The inventor has identified the variables (improvement initiatives) that have the greatest impact on the company value and has developed the computer system to measure performance in those specific areas. Because the computer system provides most information with no additional intervention, the management team is free to focus its efforts on meaningful initiatives. The computer system provides a report that projects shareholder value based on an estimated multiple (inputted) times the EBITDA and less the debt.

Reduce capital employed and debt service: A company can be profitable but not have a satisfactory cash flow because inventory is increasing, the age of accounts receivable exceeds the age of accounts payable, and depreciation expenses may exceed principle payments. To exacerbate cash flow problems the company may frequently make capital investments to accommodate new business opportunities. The inventor's approach is to optimize profit and cash flow through downsizing, generating higher capacity values, and reducing debt rather than spending capital on growth until specific operating milestones are achieved. The computer system includes cash flow analysis that compares all components of cash flow so they can be managed individually. No further input is required to get a comprehensive profit and cash flow analysis. The computer system features a cash flow report that quantifies changes and the impact on cash flow.

Metric: Performance measurements that support a company's strategy.

Sales driven company: The primary objective of a sales-driven company is to grow the top line. This is usually accomplished by making promises to customers that manufacturing may not be capable of delivering.

Manufacturing driven company: The primary objective of a manufacturing driven company is to sell to the company's manufacturing strengths and capabilities. This approach tends to limit sales growth.

Profit driven company: A profit driven company takes manufacturing capabilities and capacity value into consideration to optimize profit.

Headcount: References the number of employees, typically hourly, that would be assigned to a focus factory, or support a focus factory.

Hourly support: Non-manufacturing employees that support manufacturing e.g. maintenance mechanics and forklift operators may support more than one focus factory.

Overview:

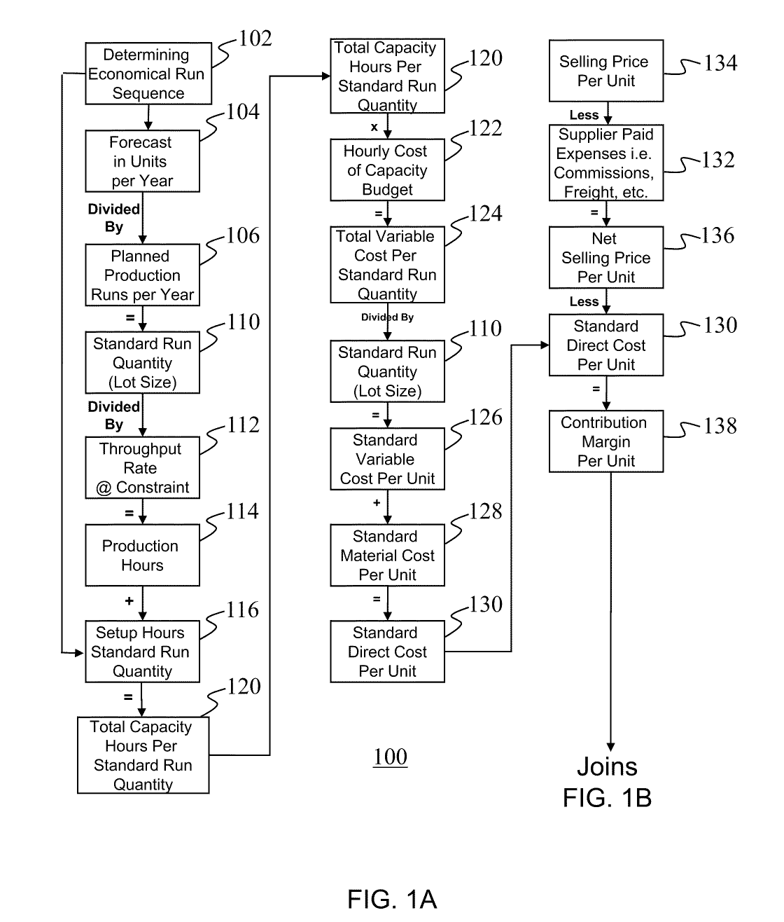

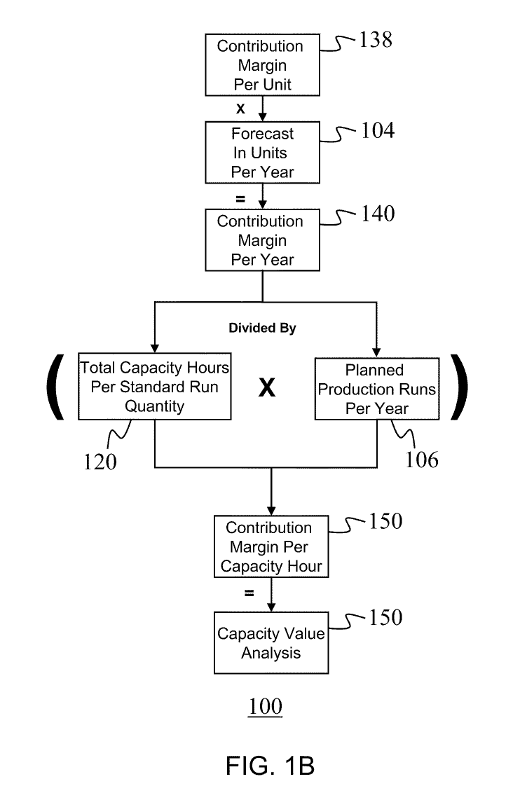

As illustrated in FIGS. 1A through 6, embodiments of this invention provide a better system and method for analyzing the profitability of a company's products and services and then maximizing that profit. This will enable a company to quantify the most lucrative business opportunities so necessary steps may be taken to secure such opportunities. This will further increase profit from existing capacity, avoiding the need for capital investments that increase debt and debt service. A contribution margin per unit 138 is multiplied times the forecast in units per year 104. The product of this contribution margin per unit 138 times the forecast in units per year 104 is divided by the product of the total capacity hours per standard run quantity 120 and the planned production runs per year 106. The result is the contribution margin per capacity hour 150 which is also defined here as the capacity value analysis 150. The capacity value analysis 150 provides a means for determining product rationalization, and profitable growth determination, as well as a metric for profit optimization initiatives such as eliminating constraints, customer perceived value, design for manufacturability, reduced production frequency, and reduced setup time.

Embodiments of methods for capacity value analysis:

As illustrated in FIGS. 1A and 1B, a method 100 for providing profit optimization of products and services in one embodiment may comprise the steps of: determining an economical run sequence to minimize setup time 102; determining a forecast in units per year 104; determining a number of planned production runs per year 106; determining a standard run quantity 110, which may be called the lot size, by dividing the forecast in units per year 104 by the number of planned production runs per year 106; determining a throughput rate at a constraint 112; determining a production hours 114 by dividing the standard run quantity 110 by the throughput rate at the constraint 112; determining a setup time in hours per standard run quantity 116; determining a total capacity hours per standard run quantity 120 by adding the setup time in hours per standard run quantity 116 with the production hours 114; determining an hourly cost of capacity budget 122; determining a total variable cost per standard run quantity 124 by multiplying the total capacity hours per standard run quantity 120 times the hourly cost of capacity budget 122; determining a standard variable cost per unit 126 by dividing the total variable cost per standard run quantity 124 by the standard run quantity 110; determining a standard material cost per unit 128; determining a standard direct cost per unit 130 by adding the standard variable cost per unit 126 and the standard material cost per unit 128; determining expenses paid to a supplier 132; determining a selling price of a product per unit 134; determining a net selling price per unit 136 by subtracting the expenses paid to the supplier 132 from the selling price of the product per unit 134; determining the contribution margin per unit 138 by subtracting the standard direct cost per unit 130 from the net selling price per unit 136; determining a contribution margin per year 140 by multiplying the contribution margin per unit 138 times the forecast in units per year 104; determining a product of the total capacity hours per standard run quantity 120 times the number of planned production runs per year 106; and determining a capacity value analysis 150 by dividing the contribution margin per year 140 by the product of the total capacity hours per standard run quantity 120 times the number of planned production runs per year 106 wherein the capacity value analysis 150 aids in determining the maximum profitability of a company's products and services by concentration on the company's products and services that are the most profitable. The economical run sequence 102 is established by determining a sequence before the start of production that focuses on using minimum setup time. The master production schedule, which is organized in an economical run sequence 102, may be populated with actual customer releases and/or planned inventory shortages. Each finished product assigned to a focus factory is ranked in an economical run sequence 102 that becomes the template for the master production schedule. A focus factory manufactures all similar products providing capacity is available. Customer orders/releases are input to the master production schedule. The forecast in units per year 104 is sales projections for a specific product for the following twelve months, e.g. Ford may project to sell 200,000 Fusions in 2009. The annual sales forecast in units 104 is input for a particular finished product. The number of planned production runs per year 106 is the number of times annually that a product is planned to be manufactured. The planned production runs 106 typically correspond with the lead-time that is committed to the customer, e.g. a four week customer lead-time would mean the product would be produced thirteen times per year (52 weeks per year/4 week lead-time)=13 production runs per year. The number of production runs per year 106 may be input for each focus factory but can be modified based on a unique agreement made with a specific customer. The standard run quantity 110 is the forecast in units per year 104 divided by the planned production runs 106, typically this is same as the customer lead-time and shipments. The throughput rate at the constraint 112 is the slowest process in a manufacturing flow to manufacture a finished product. The constraint dictates the throughput rate. The throughput rate is established by determining the time required to complete each process e.g. a 60 second cycle equates to 60 units per hour (360 seconds per hour/60 seconds per unit)=60 units per hour. Non-constraint processes are all the incremental processes other than the constraint. Non-constraint processes may be combined into a work center so that multiple processes to supply the constraint may be performed with fewer people. Each process is timed and input for each finished product. The production hours 114 or number of hours at standard that are needed to manufacture the standard run quantity 110 are based on dividing the standard run quantity 110 by the throughput rate at the constraint 112. The setup hours per standard run quantity 116 is the time it takes from stopping production of one product to manufacturing conforming parts of the next product in the economical run sequence 102. The setup hours are assigned to the subsequent product. The standard setup time is established. The total capacity hours per standard run quantity 120 includes both setup hours 116 and production hours 114 when determining the hours required to manufacture a standard run quantity 110 and the contribution margin per capacity hour 150, or capacity value analysis 150. The hourly cost of capacity budget 122 is the variable spending directly associated with the manufacturing processes that are more time, than production sensitive. Labor, supplies, maintenance and possibly other expenses specific to the industry are considered variable expenses. An hourly budget is established to represent acceptable spending for the combination of processes, or capacity, during the manufacturing process. The budget for cost of capacity 122 is established and used for each focus factory. Finished products are assigned to a focus factory. The total variable cost per standard run quantity 124 is determined by multiplying the total capacity hours per standard run quantity 120 times the hourly cost of capacity budget 122. No additional input is required other than those previously stated. The cost to manufacture a finished product or the standard variable cost per unit 126 is determined by dividing the total variable cost per standard run quantity 124 by the standard run quantity 110. The standard material cost 128 includes the cost of raw materials and purchased parts based on the standard quantity and the standard purchase price. Typically, the standard material cost per unit 128 is the sum of the bill of materials that are required to manufacture a finished product. A material item master may be developed that includes the raw materials and purchase parts at standard cost. The item master also includes other important data i.e. minimum purchase quantities, box quantities, suppliers, and standard purchase price to mention a few. A bill of materials is developed for each finished product based on the quantities required. The cost for each raw material and purchase part is based on the quantity times the standard cost, or a delivered cost. The standard direct cost per unit 128 is determined by adding the standard variable cost per unit 126 plus the standard material cost per unit 128. The standard direct cost per unit 126 represents the total manufacturing cost of a finished product and does not include allocated costs that are not directly related to the manufacturing process. Moreover, direct costs could be avoided if a manufacturing process was not scheduled. The selling price per unit 134 is the quoted customer selling price of a finished product. The target selling price of each finished product must be modified with the actual selling price that was quoted. The target selling price is based on a target contribution margin per hour that is input for each focus factory based on estimated market value. Supplier paid expenses 132 are calculated as non-manufacturing expenses that are paid by the supplier and that reduce the contribution margin of the finished product. Some typical deductions include commissions and freight. The supplier paid expenses 132 are deducted from the selling price per unit 134. The net selling price 136 is the customer selling price less non-manufacturing expenses. The selling price per unit 134 as previously discussed is the customer invoice price of a finished product and the non-manufacturing expenses are deducted from the selling price per unit 134 to determine the net selling price 136. The contribution margin per unit 138 is the net selling price of a unit 136 less the standard direct cost per unit 130. The direct cost does not include fixed overhead allocations therefore contribution margin pays fixed overhead expenses. The contribution margin per year 140 for a particular finished product is determined by multiplying the contribution margin per unit 138 times the forecasted units per year 104. The contribution margin per capacity hour 150 is the contribution margin per year 140 divided by the product of total capacity hours per standard run quantity 120 and planned production runs per year 106. Capacity should be considered a commodity, or limited resource, therefore it is crucial to maximize the contribution margin that is generated from capacity. Capacity requires a capital investment, justifies fixed overhead spending, and dictates the profit potential of a company. Capacity value analysis 150 is the name the inventor has assigned to contribution margin per capacity hour 150. There are a number of costing/pricing methodologies, any one of which can establish a market price. Capacity value analysis 150 provides a standardized benchmark to evaluate and maximize product profitability. Moreover, using capacity value analysis 150 for pricing enables a company to cherry-pick the opportunities that are most lucrative. Each finished product has a capacity value that is either above, or below the target. Numerous reports may be developed for making pricing, jettison, and marketing decisions. Capacity values may be assigned to other criteria, i.e. capacity values by customer, geographic location, etc that improves the effectiveness of management decisions.

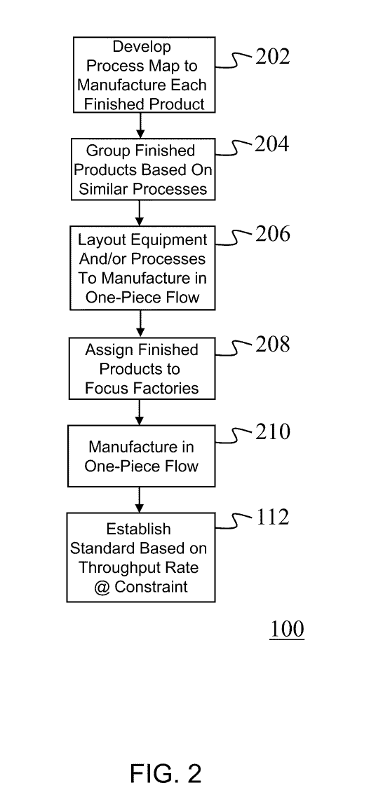

As illustrated in FIG. 2, one embodiment of a method 100 further includes the steps of determining: a process map per finished product 202, a grouping for finished products based on similar processes 204 based on the process map per finished product 202, a layout of equipment and processes to manufacture in a one-piece flow 206 based on the group finished products based on similar processes 204, assignment of finished products to a focus factory 208 for manufacture in the one-piece flow, and a standard based on the throughput rate at the constraint 112 by manufacturing in a one-piece flow 210. Developing a process map 202 considers manufacturing a finished product requiring one, or more, processes. Accordingly, the list of processes required to manufacture a finished product is commonly referred to as a process map 202. An individual, or individuals, design the most efficient processes to manufacture a finished product. The processes are assigned to a focus factory that would manufacture all similar products providing capacity is available. The user may establish processes that mirror the manufacturing floor. The process map 202 represents a particular focus factory, or series of processes devoted to manufacturing similar products. Grouping finished products based on similar processes 204 considers finished products that require the same, or similar, processes can likely be manufactured within the same focus factory if capacity is sufficient. Therefore, each finished product would be assigned to the most appropriate focus factory with other similar products. The user must assign each finished product to the most appropriate focus factory that includes the processes required. The cycle time for each process is considered. Each finished product must be assigned to a focus factory before a standard cost and selling price can be established. Laying out equipment and/or processes 206 considers that once processes required to manufacture similar products have been identified 204, an efficient plant layout for each focus factory can be designed. The goal is to group processes into workstations so that the combined cycle time is the same as other processes therefore minimizing headcount. The most efficient layout is designed based on the manufacturing processes needed to manufacture similar products. Manufacture in a one-piece flow 210 considers that one part at a time should be transferred from process to process instead of transferring batches of parts. A one-piece manufacturing flow 210 enables the next process to detect a bad part before there are many bad parts and the constraint is more easily identified. Manufacturing processes should be configured in reasonable proximity of one another to avoid batching, queuing, and unnecessary transferring of parts. Typically work-in-process based on material cost only should be recognized to discourage batch and queue manufacturing. Standard costs are only earned when a finished product is manufactured. A goal is to group processes into workstations so that the combined cycle time is the same as other processes therefore minimizing hourly workers/headcount. The most efficient layout is designed based on the manufacturing processes needed to manufacture similar products.

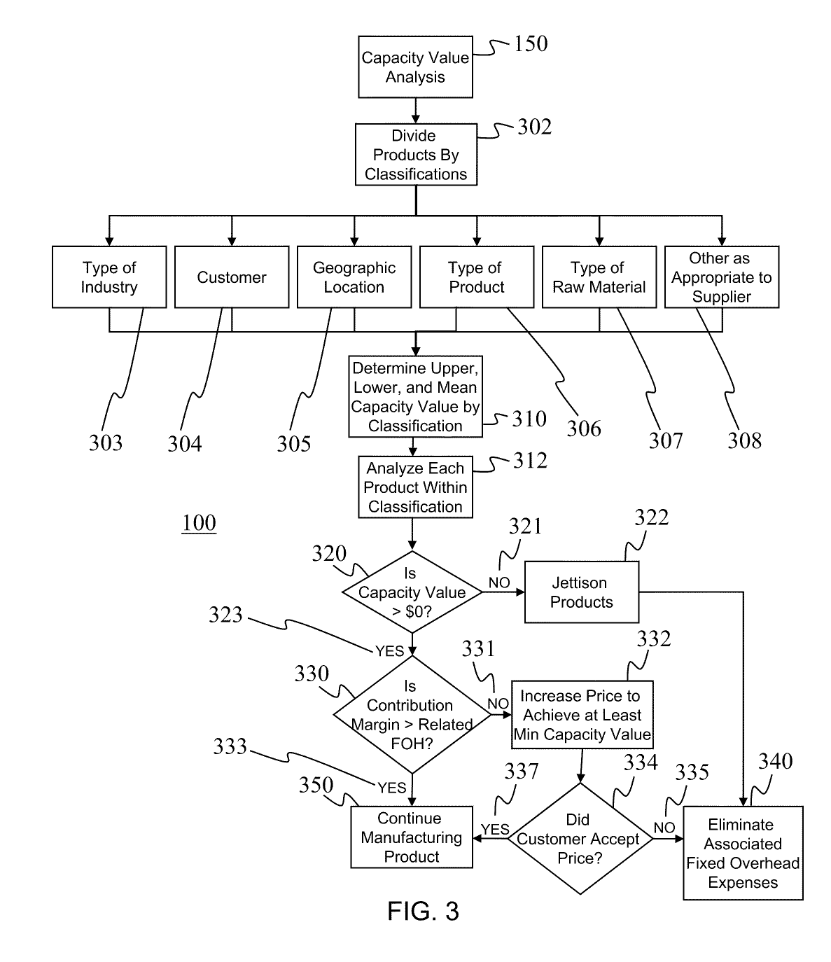

As depicted in FIG. 3, the method 100 for providing profit optimization of products and services may include, after the step of determining a capacity value analysis 150, the capacity value analysis 150 provides product rationalization with the additional steps of: dividing the products by classifications 302 including but not limited to: type of industry 303, customer 304, geographic location 305, type of product 306, type of raw material 307, and other as appropriate to supplier 308; determining an upper, lower, and mean capacity value by the classification 310; analyzing each product within the classification 312: if capacity value is not greater than zero dollars 320, 321 then jettison products with negative capacity value 322 and eliminate the associated fixed overhead expenses 340; if capacity value is greater than zero dollars 320, 323 and if annual contribution margin is greater than related fixed overhead 330, 333 then continue manufacturing the product 350; if capacity value is greater than zero dollars 320, 323, and if the annual contribution margin related fixed overhead is not greater than the related fixed overhead 330, 331, then increase price to achieve at least min capacity value 332, and if customer accepted price 334, 337, continue manufacturing the product 350; and if capacity value is greater than zero dollars 320, 323, and if the annual contribution margin is not greater than the related fixed overhead 330, 321, then increase price to achieve at least minimum capacity value 332, and if customer did not accept the accepted price 334, 335, eliminate the associated fixed overhead expenses 340. Dividing the products into classifications 302 may include optimizing product profitability with an ongoing evaluation of what attributes may affect selling prices and capacity values. Accordingly, capacity value analysis 150 may be assigned to a variety of product classifications 302, i.e. type of industry 303, customer 304, geographic location 305, type of product 306, and type of raw material 307 to name a few. After identifying the more lucrative markets a sales and marketing strategy should be developed to secure new opportunities. The user may establish finished product classifications to evaluate the most lucrative finished products. The steps of determining upper, lower and mean capacity values by classification 310 further includes determining the range between upper and lower capacity values within a focus factory, or finished product classification, indicating the pricing disparities within a market. The mean capacity value, which is a weighted average calculated by dividing the total annual contribution margin by the total annual capacity hours, is perhaps is the best indicator of market pricing. The objective is to continually increase the mean capacity value by addressing the products that are below the mean. To increase capacity values and improve profitability the management team must constantly re-evaluate the most lucrative use of capacity. The products are evaluated based on capacity value and contribution margin. If the capacity value is below $0 321, the products and associated fixed overhead expenses should be jettisoned. A company often has a substantial amount of under-contributing products that add complexity to the company. Moreover, complexity justifies additional management and administrative resources. It may be more expedient to jettison products 322 and/or customers so the organization can be right-sized than to issue price increases. In most cases, the expenses that are cut far exceed the contribution margin that is lost from jettisoning. Although a product may generate a positive capacity value and contribution margin, it may be under-priced if similar products have higher capacity values. If price increases result in a loss of business, reduce overhead to offset the loss of contribution margin. Fixed overhead expenses have been omitted when calculating contribution margin however, contribution margin should exceed the fixed overhead expenses that would have been allocated. A company must constantly pursue the most contribution margin from the least amount of capacity. This may be accomplished through price adjustments if products seem to be significantly under-priced based on capacity values of similar products. Eliminate associated fixed overhead expenses 340: All expenses other than those directly assigned to a finished product are considered fixed overhead expenses. These expenses remain relatively constant even when sales fluctuate. Fixed overhead expenses are paid from contribution margin that is generated from sales. An ongoing challenge is to simplify operations and reduce fixed overhead. A fixed overhead budget should be established and compared with actual spending. Fixed overhead expenses are relatively constant and a conscious effort must be made to reduce them.

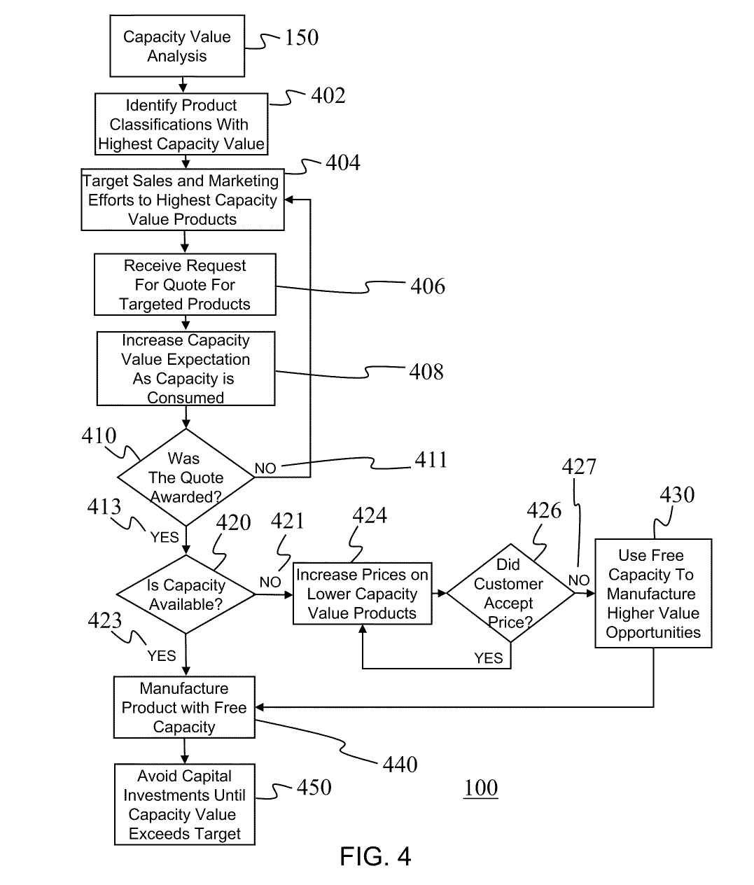

As depicted in FIG. 4, the method 100 for providing profit optimization of products and services may include after the step of determining a capacity value analysis 150 the capacity value analysis 150 provides profitable growth with the additional steps of: determining product classifications with highest capacity value 402; determining target sales and marketing efforts to highest capacity value products 404; receiving a request for quote for targeted products 406; increasing capacity value expectation as capacity is consumed 408; if quote was not awarded 410, 411 repeat steps of determining target sales and marketing efforts 404 through increasing capacity value expectation 408; and if quote was awarded 410, 413 determining if capacity is available 420, if capacity is available 423, manufacturing product with free capacity 440 minimizing capital investments until capacity value exceeds target 450, and if capacity is not available 421, increasing prices on lower capacity value products until customer does not accept price 424, 426, 427, then use free capacity to higher value opportunities 430 and manufacturing product with free capacity 440 minimizing capital investments until capacity value exceeds target 450. Targeting sales and marketing efforts to highest capacity value products 404: It is not uncommon for companies to pursue sales at the expense of contribution margin and capacity value. Identifying the most lucrative opportunities enables a company to focus sales and marketing efforts accordingly, therefore reducing expenses while improving contribution margin. Receiving a request for quote for targeted products 406: An opportunity provided by a new, or existing customer to determine if the company is market competitive. Inasmuch as possible, a request for quote would be the result of targeted sales and marketing efforts. Quoting is providing a price to a prospective customer for a new product or service. Increasing capacity value expectation 408: Capacity is a limited resource, which should increase in value as it is consumed, or depleted. This pricing philosophy is in concert with the “law of supply and demand”, which could be translated as “when capacity is consumed it should increase in value”. This approach is in sharp contrast with the incremental pricing philosophy that suggests it is appropriate to lower margins once fixed overhead expenses have been covered. The latter approach has at least two significant flaws: 1) lower prices on new opportunities will drive market values down on existing business, and 2) new opportunities with lower margin may not financially justify capital investments for additional capacity. Pricing decisions that support a business strategy must strictly monitored by management to insure conformance. Free capacity is the difference between available capacity and utilized capacity. Free capacity represents an opportunity to add new business and it may be valued based on a realistic capacity value, typically the mean, e.g. 2,000 hours of free capacity at a mean capacity value of $100 per hour represents $200,000 in potential contribution margin annually. To avoid unnecessary capital investments it is important that the mean capacity value meets/or exceeds the target and capacity is substantially utilized before adding capacity. Capital investments for process improvements may be justified based on cost reductions. Actual pricing and capital investment decisions must be made based on risk and reward.

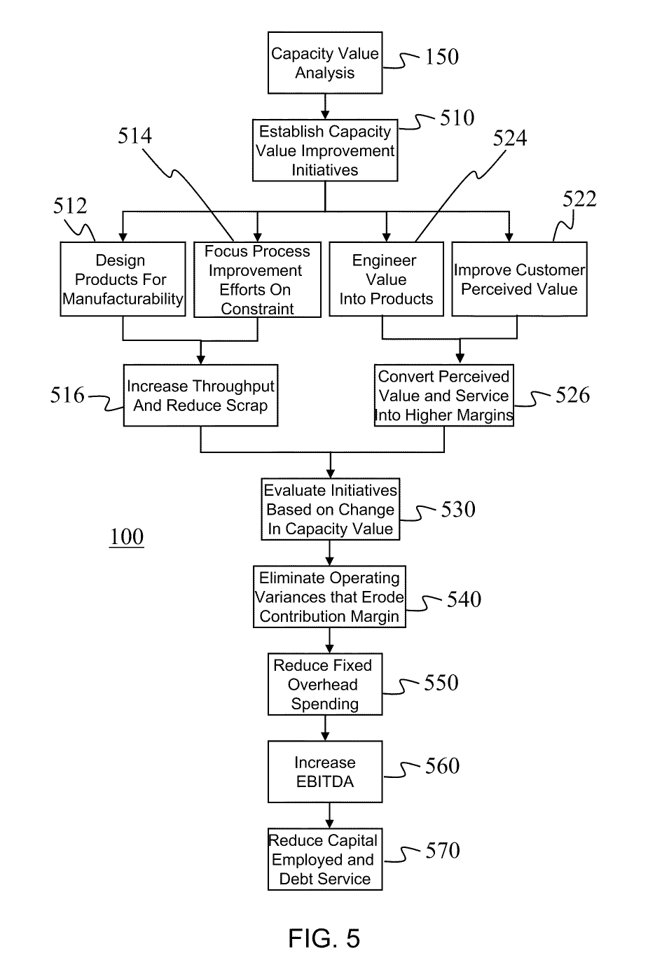

As depicted in FIG. 5, the method 100 for providing profit optimization of products and services may include after the step of determining a capacity value analysis 150 the capacity value analysis 150 provides metric for profit optimization initiatives with the additional steps of: establishing capacity value improvement initiatives 510 by: designing for manufacturability 512 and increasing throughput and reducing scrap 516, focus process improvement efforts on the constraint 514 and increasing throughput and reducing scrap 516, improving customer perceived value 522 and converting perceived value and service into higher margins 526, value engineering into products 524 and converting perceived value and service into higher margins 526; evaluating initiatives based on change in capacity value 530; eliminating operating variances that erode contribution margin 540, reducing fixed overhead spending 550; increasing EBITDA 560; and increasing business value by reducing capital employed and debt service 570. Capacity value improvement initiatives 510 focus on increasing throughput (producing more in less time) and increasing the selling price (more contribution margin during the same time). These initiatives improve profitability as well as profit potential as free capacity increases (more capacity for new opportunities) and higher capacity value (free capacity would have higher market value). The change in capacity value quantifies the effectiveness of each improvement initiative. Management must outline the improvement initiatives that will be measured against the standard capacity value. The updated capacity value (after completing the initiative) will be compared to the original standard. Accordingly, improvements in capacity value can be the basis for incentive pay. Capacity value history may be archived so that each initiative is measured against a new standard. To change the capacity value a new throughput rate, selling price, and/or cost reductions must be input. Changing a product design so the function remains the same but it is easier to manufacture is designing products for manufacturability 512. Typically, the benefit of this capacity value improvement initiative is lower cost and higher throughput. Management must outline the new product design and process changes. The updated capacity value (after completing the initiative) will be compared to the original standard and new standards must be input. To change the capacity value a new throughput rate, selling price, and/or cost reductions must be input. With throughput at the constraint, if more than one process is required to manufacture a finished product, the constraint, or slowest process, determines the throughput rate for product costing and capacity value analysis. Restated, improving the throughput rate of non-constraint processes will not affect the overall throughput rate, nor is it likely to reduce product cost. A manufacturing initiative should be to continually improve throughput at the process constraint. Management must outline the process changes to improve throughput at the constraint. The updated capacity value (after completing the initiative) will be compared to the original standard. New standards must be input. The archives of capacity value history depict the effects of the higher throughput rate that can be measured against the original capacity value standard. To change the capacity value, a new throughput rate, selling price, and/or cost reductions must be input. For value engineering for finished products 524, in addition to designing products for ease of manufacturing, products may be designed to perform better, or may even be a unique design that eliminates the competition. In any case, value engineering equates to a higher selling price, higher margin, and higher capacity value, all of which would be achieved because the product is considered superior. Management must outline the benefits and cost of the value engineered product to anticipate the capacity value improvement. The updated capacity value (after completing the initiative) will be compared to the original standard and new standards must be input. The capacity value history is archived so the effects of the engineering changes can be measured against the original capacity value standard. To change the capacity value a new bill of materials and selling price are likely to require inputs. Improving customer perceived value 522: If customer relationships are good the supplier's price does not always have to be the least expensive. There may be intangible aspects of the relationship that will overshadow price, i.e. quality, on-time delivery, and responsiveness. The supplier should always listen to what the customer feels is most important and design manufacturing processes and systems to improve customer perceived value. The improved relationship could equate to higher prices and capacity values than the competitors. Management must listen attentively to customer's needs and improve the relationship. Perhaps the customer wants more frequent deliveries and it can be accomplished with little or no increase in cost. If so, the customer may accept a higher price for the added convenience. Regardless of the initiative, updated capacity value (after completing the initiative) 530 will be compared to the original standard and new standards input. The capacity value history is archived so the effects of improved customer perceived value can be measured against the original capacity value standard. To change the capacity value only the selling price may need updating. Eliminating the operating variances 540: Each finished product has a standard for cost, contribution margin and capacity value. If manufacturing is inefficient, unfavorable operating variances will increase the product cost and reduce contribution margin and capacity values. It is an ongoing profit optimization initiative to improve operations so that operating variances are favorable rather than unfavorable. A favorable operating variance would reduce product cost and increase contribution margin and capacity values. Operating variances erode standard contribution margin and company profits. Quantifying waste i.e. spending, productivity, and purchasing enable the operating variances to be eliminated, therefore increasing profitability. An ongoing objective is to improve manufacturing operations to eliminate variances 540. Unfavorable variances may result from spending more than the cost of capacity budget or producing less that the standard throughput. In either case, details are provided for each focus factory by inputting cost and production. Daily spending to budget and actual production are compared to standard, by focus factory, on a daily basis by shift. The operating variance summary, by account, links to the profit and loss statement to quantify the operating performance impact on profitability. Increasing Earnings before interest, taxes, depreciation and amortization (EBITDA) 560 represents free cash before debt service and taxes. EBITDA is commonly considered the most important financial metric to value a company. Specifically, a company typically sells based on a multiple of EBITDA, e.g. $3 million in EBITDA times a multiple of 5 would mean the company would sell for $15 million less the debt. The inventor's objective is to increase EBITDA while reducing the debt to optimize shareholder value 570. Increasing EBITDA and shareholder value should be a primary concern of any company. The inventor has identified the variables (improvement initiatives) that have the greatest impact and has developed a method to measure performance in those specific areas. A report that projects shareholder value based on an estimated multiple (inputted) times the EBITDA and less the debt may be developed. To reduce capital employed and debt service 570: A company can be profitable but not cash flow because inventory is increasing, the age of accounts receivable is greater than accounts payable, and depreciation expenses may exceed principle payments. To exacerbate cash flow problems the company may frequently make capital investments to accommodate new business opportunities. The inventor's approach is to optimize profit and cash flow through downsizing, generating higher capacity values, and reducing debt rather than spending capital on growth until specific operating milestones are achieved. Cash flow analysis may be included that compares all components of cash flow so they can be better managed. No input is required to get a comprehensive profit and cash flow analysis. A cash flow report may be featured that quantifies changes and the impact on cash flow.

Embodiments of systems for capacity value analysis:

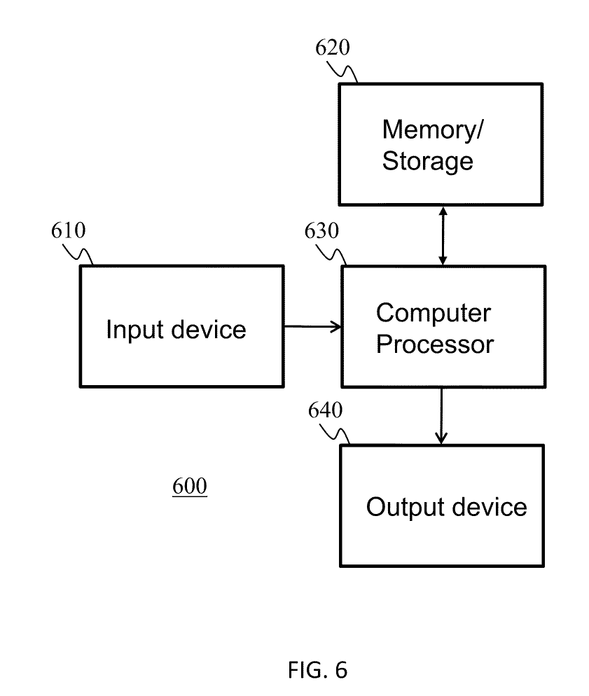

As illustrated in FIGS. 1A, 1B, and 6, the system 600 for providing profit optimization of products and services comprises the method 100 for providing profit optimization of products and services as well as the following features: a memory storage device for storing data wherein data may be stored and retrieved; an input device 610 for receiving entry of data wherein data may be input into the system; a computer processor 630 operationally connected with the input device 610 and the memory storage device 620 for determining capacity value analysis 150; the input device 610 receives data including: an economical run sequence to minimize setup time 102; a forecast in units per year 104; a number of planned production per year 106; a throughput rate at a constraint 112; a setup time in hours per standard run quantity 116; an hourly cost of capacity budget 122; a standard material cost per unit 128; expenses paid to a supplier 132; and a selling price of a product per unit 134; and the computer processor 630 determines: a standard run quantity 110 by dividing the forecast in units per year 104 by the number of planned production per year 106; a production hours 114 by dividing the standard run quantity 110 by the throughput rate at the constraint 112; the total capacity hours per standard run quantity 120 by adding the setup time in hours per standard run quantity 116 with the production hours 114; a total variable cost per standard run quantity 124 by multiplying the total capacity hours per standard run quantity 120 times the hourly cost of capacity budget 122; a standard variable cost per unit 126 by dividing the total variable cost per standard run quantity 124 by the standard run quantity 110; a standard direct cost per unit 130 by adding the standard variable cost per unit 126 and the standard material cost per unit 128; a net selling price per unit 136 by subtracting the expenses paid to the supplier 132 from the selling price of the product per unit 134; the contribution margin per unit 138 by subtracting the standard direct cost per unit 130 from the net selling price per unit 136; a contribution margin per year 140 by multiplying the contribution margin per unit 138 times the forecast in units per year 104; and the capacity value analysis 150 wherein the contribution margin per year 140 is divided by the product of the total capacity hours per standard run quantity 120 times the number of planned production runs per year 106; and an output device 640 operationally connected with the computer processor 630, the output device 640 for providing the capacity value analysis 150 to aid in determining the maximum profitability of the company's products and services that are maximized by concentration on the company's products and services that are the most profitable based on the capacity value analysis 150. Each finished product assigned to a focus factory may be ranked in an economical run sequence 102 that becomes the template for the master production schedule within the machine/computer system 600. A focus factory manufactures all similar products providing capacity is available. Customer orders/releases are input to populate the master production schedule. The master production schedule that adheres to the economical run sequence is generated within the computer system 600 based on the following logic: 1) make to customer order shortages that cannot be shipped from inventory, and 2) make to the inventory plan shortages. The automatically generated production schedule can be manually overridden. The forecast in units per year 104 is stored in the system data base or memory 620 to be used in several calculations including but not limited to; standard run quantity 110, inventory plans, and capacity plans. The number of production runs per year 106 is input for each focus factory but can be manually overridden based on a unique agreement made with a specific customer. The production runs per year 106 are denoted within the computer system 600 by selecting daily, weekly, monthly, quarterly, etc. as the frequency that a product would be manufactured. The selection is used in several calculations, i.e. standard run quantity, inventory plans, and capacity plans. The standard run quantity is computed within the computer system but can be manually overridden. The computer system 600 retains the standard run quantity 110 so it can be used in several calculations including but not limited to: production hours 114, capacity planning, and inventory planning As noted, throughput rate at the constraint 112 is the slowest process in a manufacturing flow to manufacture a finished product. Each process is timed and input into the computer system for each finished product. The computer system 600 automatically calculates the throughput rate based on the slowest cycle. All processes for each finished product are illustrated individually wherein the slowest, or constraint, may be highlighted in red. In order to increase the throughput rate the cycle time of the highlighted process must be reduced. No further input is necessary to determine the production hours. The computer system 600 calculates the production hours 114 required to manufacture the standard run quantity 110. The setup time per standard run quantity 112 is established and input. Setup time is stored in the data base in hours and automatically used in several calculations including, but not limited to; capacity hours, standard cost, and production scheduling. The total capacity hours per standard run quantity 120 requires no input to determine the total capacity hours per standard run quantity 120. The computer system 600 calculates the total capacity hours per standard run quantity 120 by dividing the standard run quantity 110 by the throughput rate at the constraint 112 to determine production hours 114, then adding the setup hours 116. The total capacity hours per standard run quantity 120 is used in several calculations including, but not limited to; capacity planning, standard cost, and capacity value analysis 150. The budget for hourly cost of capacity 122 is established and input into the computer system 600 for each focus factory. Finished products are assigned to a focus factory. An hourly cost of capacity for each focus factory is stored in the data base to be used in standard product cost calculations. The total variable cost per standard run quantity 124 requires no additional input other than those previously stored in the system memory 620 as the system determines the total variable cost per standard run quantity 124. The standard variable cost to manufacture a finished product 126 is determined by dividing the total variable cost per standard run quantity 124 by the standard run quantity 110. No additional input is required other than those previously stated. The computer system 600 computes the standard variable cost per unit 126 from data stored in the computer system memory 620. The standard material cost per unit 128 includes the cost of raw materials and purchased parts based on the standard quantity and the standard purchase price. The computer system 600 includes an item master that must be developed for each purchased item including purchase parts and raw materials. Some users may include packaging and other materials in the item master. The computer system 600 maintains a perpetual inventory based on raw material receipts, production, and cycle count adjustments. The standard direct cost per unit 130 is the sum of the standard variable cost per unit 126 plus the standard material cost per unit 128. The standard direct cost per unit 130 requires no input of additional data other than that previously mentioned. The computer system 600 stores the standard direct cost for each finished product 130 to be used for inventory valuation, performance metrics, contribution margin, and capacity value analysis 150. The selling price per unit 134 is the quoted customer selling price of a finished product. The target selling price of each finished product may be determined within the computer system 600 however, it must be manually overridden with the actual selling price that was quoted. The target selling price is based on a target contribution margin per hour that is input for each focus factory based on estimated market value. The computer system 600 provides a target selling price based on a target contribution margin per hour. The target selling price can be manually overridden to achieve more, or less, contribution margin per hour. Supplier paid expenses 132 are calculated as non-manufacturing expenses that are paid by the supplier and that reduce the contribution margin of the finished product. Supplier paid expenses 132 may be input into the computer system 600 and deducted from the selling price. The computer system 600 includes edit fields that are input to achieve a net selling price for contribution margin and capacity value analysis 150. The net selling price per unit 136 is the customer selling price less non-manufacturing expenses. There is no additional input of data required for net selling price. The computer system 600 has a selling price which is the customer invoice price of a finished product and it the computer system deducts non-manufacturing expenses to determine the net selling price. The contribution margin per unit 138 is the net selling price of a unit 136 less the standard direct cost per unit 130. There is no additional data input for determining the contribution margin per unit 138. The computer system 600 deducts all finished product related expenses to determine the contribution margin per unit 138. The data is stored for other calculations including capacity value analysis 150. The contribution margin per year 140 for each finished product is determined wherein the system multiplies the contribution margin per unit 138 times the forecast units per year 104. There is no additional data input required to determine the contribution margin per year 140 other than those previously mentioned. The computer system 600 determines the contribution margin per year 140 of each finished product. The contribution margin per capacity hour 150 is the contribution margin per year 140 divided by the product of total capacity hours per standard run quantity 120 and planned production runs per year 106. No further data input is required to determine the contribution margin per capacity hour 150 other than those previously mentioned. The computer system 600 calculates contribution margin per capacity hour 150 for each finished product and uses the data to determine the market value of processes and target pricing. Capacity value analysis 150 is the name the inventor has assigned to contribution margin per capacity hour 150. The computer system 600 provides numerous reports that are available upon request for making pricing, jettison, and marketing decisions. Each finished product has a capacity value that is stored in the computer system data base. In addition to products, capacity values are assigned to other criteria within the computer system, i.e. capacity values by customer, geographic location, etc that improves the effectiveness of management decisions.

As illustrated in FIGS. 1A, 1B, 2 and 6, one embodiment of the system 600 for providing profit optimization of products and services may further comprises the method 100 for providing profit optimization of products and services as well as the following features: a process map may be developed to manufacture each finished product 202 and establish or determine a standard based on the throughput rate at the constraint 112, and the setup time in hours per standard run quantity 116. The computer processor 600 may further determine a process map per finished product 202; determine a grouping for finished products based on similar processes 204 based on the process map per finished product 202; determine a layout of equipment and process to manufacture in a one-piece flow 206 based on the group finished products based on similar processes 204; determine assignment of finished products to a focus factory 204; and determine a standard based on the throughput rate at the constraint 112 by manufacturing in a one-piece flow 210 that is used for determining the economical run sequence 102, the throughput rate at the constraint 112, and the setup time in hours per standard run quantity 116. Manufacturing a finished product requires one, or more, processes. The processes are input into the computer system 600 as a focus factory that would manufacture all similar products providing capacity is available. Within the computer system 600 the user may establish processes that mirror the manufacturing floor. The process map 202 represents a particular focus factory, or series of processes devoted to manufacturing similar products. Although the computer system 600 retains the information for future use, all aspects of process mapping is input. For group finished products based on similar processes 204, finished products that require the same, or similar, processes can likely be manufactured within the same focus factory if capacity is sufficient. As previously stated, the cycle time for each process is also input. The computer system 600 requires that each finished product be assigned to a focus factory before a standard cost and selling price can be established. With laying out equipment and/or processes to manufacture in a one-piece flow 210, the goal is to group processes into workstations so that the combined cycle time is the same as other processes therefore minimizing hourly workers/headcount. The layout should mirror the processes that are outlined in the computer system 600 and the cycle times, that are included in the computer system 600, should influence the configuration of processes. Manufacturing in a one-piece flow 210 means that one part at a time should be transferred from process to process instead of transferring batches of parts. The computer system 600 only recognizes work-in-process based on material cost only to discourage batch and queue manufacturing. Standard costs are only earned when a finished product is manufactured.

As illustrated in FIGS. 3 and 6, one embodiment of the system 600 for providing profit optimization of products and services may further comprises the method 100 for providing profit optimization of products and services as well as the following features: The computer processor 630 provides product rationalization after determining the capacity value analysis 150 by: the input device 610 receives data including: type of industry 303, customer 304, geographic location 305, type of product 306, and type of raw material 307; and the computer processor 630 determines: an upper, lower, and mean capacity value for the classification 310; analyzing each product within the classification 312; if capacity value is not greater than zero dollars 320, 321 then the output device directs to jettison products 322 with negative capacity value and eliminate the associated fixed overhead expenses 340; if capacity value is greater than zero dollars 320, 323 and if annual contribution margin is greater than related fixed overhead 330, 333 then the output device 640 directs to continue manufacturing the product 350; if capacity value is greater than zero dollars 320, 323, and if the annual contribution margin related fixed overhead is not greater than the related fixed overhead 330, 331, then the output device 640 directs to increase price to achieve at least min capacity value 332, and if customer accepted price 334, 337, to continue manufacturing the product 350; and if capacity value is greater than zero dollars 320, 323, and if the annual contribution margin is not greater than the related fixed overhead 330, 321, then the output device 640 directs to increase price to achieve at least minimum capacity value 332, and if customer did not accept the accepted price 334, 335, the output device 640 directs to eliminate the associated fixed overhead expenses 340. Dividing the products into classifications 302 may include optimizing product profitability with an ongoing evaluation of what attributes may affect selling prices and capacity values. The user may establish finished product classifications within the computer system 600 they want to evaluate. This enables the user to determine, based on capacity values, the most lucrative finished products. The computer system 600 maintains critical data to run a variety of reports relating to capacity values. The step of determining upper, lower and mean capacity value by classification 310 further includes determining the range between upper and lower capacity values within a focus factory, or finished product classification, indicating the pricing disparities within a market. The mean capacity value, which is a weighted average calculated by dividing the total annual contribution margin by the total annual capacity hours, is perhaps is the best indicator of market pricing. The objective is to continually increase the mean capacity value by addressing the products that are below the mean. To increase capacity values and improve profitability the management team must constantly re-evaluate the most lucrative use of capacity. The computer system 600 provides graphs from stored data that illustrate capacity value ranges. With respect to jettison products 322 and associated fixed overhead, evaluating the data and taking the necessary steps requires human intervention although the system 600 provides the necessary data and reports. All the data needed to make difficult decisions is provided by the system output 640 with no additional data inputs other than running reports. Eliminate associated fixed overhead expenses 340: All expenses other than those directly assigned to a finished product are considered fixed overhead expenses. These expenses remain relatively constant even when sales fluctuate. Fixed overhead expenses are paid from contribution margin that is generated from sales. An ongoing challenge is to simplify operations and reduce fixed overhead. A fixed overhead budget should be established and compared with actual spending. Fixed overhead expenses are relatively constant and a conscious effort must be made to reduce them. The computer system 600 provides a fixed overhead budget that is input. Actual spending is charged to the accounts either through the disbursements journal or accounts payable. The profit and loss statement includes a fixed overhead budget variance so fixed overhead spending can be evaluated.

As illustrated in FIGS. 4, and 6, one embodiment of the system 600 for providing profit optimization of products and services further comprises the method 100 for providing profit optimization of products and services as well as the following features: the system 600 may provide profitable growth of the products and services after determining the capacity value analysis 150 by the input device 610 receiving the input of the data of product classifications with highest capacity value 402; target sales and marketing efforts to highest capacity value products 404; request for quote for targeted products 406; increase capacity value expectation as capacity is consumed 408 and the computer processor determines: if quote was not awarded 410, 411 repeat the steps of receiving target highest capacity value products 404; request for quote 406; through increase capacity value expectation as capacity is consumed 408; if quote was awarded 410, 413 determine if capacity is available 420, and if capacity is available 423, manufacture product with free capacity 440 minimizing capital investments until capacity value exceeds target 450, and if capacity is not available 421, increase prices on lower capacity value products until customer does not accept price 424, 426, 427, then use free capacity for higher value opportunities 430 and manufacture product with free capacity 440 minimizing capital investments until capacity value exceeds target 450. Target sales and marketing efforts to highest capacity value products 404 is an effect approach since it is not uncommon for companies to pursue sales at the expense of contribution margin and capacity value. The sales and marketing strategy may be developed by management using the data provided by the computer system 600. The computer system 600 provides capacity value graphs and reports without inputting additional data. In receiving a request for quote for targeted products 406, an opportunity is provided by a new or existing customer to determine if the company is market competitive. The user must input critical information into the computer system 600 so that a target price can be provided. The target price can be overridden by the user so that the capacity value would be adjusted accordingly. The computer system 600 may include a comprehensive quoting package that requires inputting critical information. Increasing capacity value expectation 408: Capacity is a limited resource, which should increase in value as it is consumed, or depleted. Pricing decisions that support a business strategy must strictly monitored by management to insure conformance. The computer system 600 may provide an ongoing comparison between the original mean capacity value and the current mean capacity value to insure capacity value is continually increasing as capacity is consumed. No additional data must be input. Free capacity is the difference between available capacity and utilized capacity. No human intervention is required to determine the amount of free capacity that is available within a focus factory or the mean value of that capacity. The computer system 600 provides free capacity by focus factory and the potential annual contribution margin based on the mean capacity value. No additional inputs are required to determine the growth potential of the company. To avoid unnecessary capital investments it is important that the mean capacity value meets/or exceeds the target and capacity is substantially utilized before adding capacity. Capital investments for process improvements may be justified based on cost reductions. Capacity value information is provided within the computer system 600 however actual pricing and capital investment decisions must be made based on risk and reward. The computer system 600 provides real time mean capacity values based on the active products within each focus factory and automatically utilizes this information to arrive at suggest pricing for new opportunities.

As illustrated in FIGS. 5, and 6, one embodiment of the system 600 for providing profit optimization of products and services further comprises the method 100 for providing profit optimization of products and services as well as the following features: the system 600 may further provides metric for profit optimization initiatives by the input device 610 receiving the input of the data for establishing capacity value improvement initiatives 510 by designing for manufacturability 512, and increasing throughput and reducing scrap 516; focus process improvement efforts on the constraint 514, and increasing throughput and reducing scrap 516; improving customer perceived value 522 and converting perceived value and service into higher margins 526; value engineering into products 524 and converting perceived value and service into higher margins 526; and the computer processor 630: evaluates initiatives based on change in capacity value 530, eliminating operating variances 540, reducing fixed overhead spending 550, increasing EBITDA 560, and increasing business value by reducing capital employed and debt service 570. Capacity value improvement initiatives focus on increasing throughput (producing more in less time) and increasing the selling price (more contribution margin during the same time). The computer system 600 archives capacity value history so that each initiative is measured against a new standard. To change the capacity value a new throughput rate, selling price, and/or cost reductions must be input. Changing a product design so the function remains the same but it is easier to manufacture is designing products for manufacturability. Typically, the benefit of establishing the capacity value improvement initiatives 510 is lower cost and higher throughput. Management must outline the new product design and process changes. The updated capacity value (after completing the initiative) will be compared to the original standard and the new standards input into the computer system 600. The computer system 600 archives capacity value history so the effectiveness of the new product design can be measured against the original capacity value standard. To change the capacity value a new throughput rate, selling price, and/or cost reductions must be input. With throughput at the constraint, if more than one process is required to manufacture a finished product, the constraint, or slowest process, determines the throughput rate for product costing and capacity value analysis 150. New standards may be input into the computer system 600. The computer system 600 archives capacity value history so the effects of the higher throughput rate can be measured against the original capacity value standard. To change the capacity value a new throughput rate, selling price, and/or cost reductions must be input. For value engineering for finished products 524, in addition to designing products for ease of manufacturing, products may be designed to perform better, or may even be a unique design that eliminates the competition. In any case, value engineering equates to a higher selling price, higher margin, and higher capacity value, all of which would be achieved because the product is considered superior. Management must outline the benefits and cost of the value engineered product to anticipate the capacity value improvement. The updated capacity value (after completing the initiative) will be compared to the original standard. New standards must be input into the computer system 600. The computer system 600 archives capacity value history so the effects of the engineering changes can be measured against the original capacity value standard. To change the capacity value a new bill of materials and selling price are likely to require further input. Improving customer perceived value 522: If customer relationships are good the supplier's price does not always have to be the least expensive. There may be intangible aspects of the relationship that will overshadow price, i.e. quality, on-time delivery, and responsiveness. Regardless of the initiative, updated capacity value (after completing the initiative) will be compared to the original standard. New standards must be input into the computer system 600. The computer system 600 archives capacity value history so the effects of improved customer perceived value can be measured against the original capacity value standard. To change the capacity value only the selling price may need updating. Eliminating the operating variances 540: Each finished product has a standard for cost, contribution margin and capacity value. If manufacturing is inefficient, unfavorable operating variances will increase the product cost and reduce contribution margin and capacity values. It is an ongoing profit optimization initiative to improve operations so that operating variances are favorable rather than unfavorable. The computer system 600 provides details for each focus factory by inputting cost and production. The computer system 600 compares daily spending to budget and actual production to standard, by focus factory, on a daily basis by shift. The operating variance summary, by account, links to the profit and loss statement to quantify the operating performance impact on profitability. Increasing EBITDA 560: Earnings before interest, taxes, depreciation and amortization represents free cash before debt service and taxes. EBITDA is commonly considered the most important financial metric to value a company. The inventor has identified the variables (improvement initiatives) that have the greatest impact and has developed the computer system 600 to measure performance in those specific areas. Because the computer system 600 provides most information with no additional intervention, the management team is free to focus its efforts on meaningful initiatives. The computer system 600 may include a report that projects shareholder value based on an estimated multiple (inputted) times the EBITDA and less the debt. To reduce capital employed and debt service 570: A company can be profitable but not cash flow because inventory is increasing, the age of accounts receivable is greater than accounts payable, and depreciation expenses may exceed principle payments. To exacerbate cash flow problems the company may frequently make capital investments to accommodate new business opportunities. The computer system 600 includes cash flow analysis that compares all components of cash flow so they can be better managed. No further input is required to get a comprehensive profit and cash flow analysis. The computer system 600 features a cash flow report that quantifies changes and the impact on cash flow.

Embodiments of computer-readable mediums for capacity value analysis:

The term “computer-readable medium” or “machine-readable medium” is broadly defined to include any kind of computer memory such as floppy disks, conventional hard disks, CD-ROMS, Flash ROMS, nonvolatile ROM, and RAM.

As illustrated in FIGS. 1A, 1B, and 6, one embodiment includes a computer-readable medium having computer-executable instructions which when executed by a computer system 600 cause the computer processor 630 to perform operations that provide for profit optimization comprising instructions for: receiving data of: an economical run sequence to minimize setup time 102, a forecast in units per year 104, a number of planned production runs per year 106, a throughput rate at a constraint 112, a setup time in hours per standard run quantity 116, an hourly cost of capacity budget 122, a standard material cost per unit 128, a selling price of a product per unit 134, and an expenses paid to a supplier 132; and instructions for the computer processor 630 for determining: a standard run quantity 110 by dividing the forecast in units per year 104 by the number of planned production per year 106; a production hours 114 by dividing the standard run quantity 110 by the throughput rate at the constraint 112; the total capacity hours per standard run quantity 120 by adding the setup time in hours per standard run quantity 116 with the production hours 114; a total variable cost per standard run quantity 124 by multiplying the total capacity hours per standard run quantity times 120 the hourly cost of capacity budget 122; a standard variable cost per unit 126 by dividing the total variable cost per standard run quantity 124 by the standard run quantity 110; a standard direct cost per unit 130 by adding the standard variable cost per unit 126 and the standard material cost per unit 128; a net selling price per unit 136 by subtracting the expenses paid to the supplier 132 from the selling price of the product per unit 134; the contribution margin per unit 138 by subtracting the standard direct cost per unit 130 from the net selling price per unit 136; and a contribution margin per year 140 by multiplying the contribution margin per unit 138 times the forecast in units per year 104; and the capacity value analysis 150 wherein the contribution margin per year 140 is divided by the product of the total capacity hours per standard run quantity 120 times the number of planned production runs per year 106 wherein the capacity value analysis 150 aids in determining the maximum profitability of a company's products and services by concentration on the company's products and services that are the most profitable.

As illustrated in FIGS. 1A, 2, and 6, another embodiment may include a computer-readable medium which may further include computer-executable instructions, wherein the computer processor 630 further performs operations comprising: determining a process map per finished product 202; determining a grouping for finished products based on similar processes 204 based on the process map per finished product 202; determining a layout of equipment and processes to manufacture in a one-piece flow 206 based on the group finished products based on similar processes; determining assignment of finished products to a focus factory 208; and determining a standard based on the throughput rate at the constraint 112 by manufacturing in a one-piece flow 210 that is used for determining the economical run sequence 102, the throughput rate at the constraint 112, and the setup time in hours per standard run quantity 116.

As illustrated in FIGS. 3, and 6, another embodiment may include a computer-readable medium which may further include computer-executable instructions, wherein the capacity value analysis 150 provides product rationalization and the computer processor 630 performs the additional steps of: receiving the input of the data of the products by classifications 302 including: type of industry 303, customer 304, geographic location 305, type of product 306, type of raw material content 307, and other as appropriate to supplier 308; determining an upper, lower, and mean capacity value by the classification 310; analyzing each product within the classification 312: if capacity value is not greater than zero dollars 320, 321 then jettison products 322 with negative capacity value and eliminate the associated fixed overhead expenses 340; if capacity value is greater than zero dollars 320, 323 and if annual contribution margin is greater than related fixed overhead 330, 333 then continue manufacturing the product 350; if capacity value is greater than zero dollars 320, 323, and if the annual contribution margin related fixed overhead is not greater than the related fixed overhead 330, 331, then increase price to achieve at least min capacity value 332, and if customer accepted price 337, continue manufacturing the product 350; and if capacity value is greater than zero dollars 320, 323, and if the annual contribution margin is not greater than the related fixed overhead 330, 331, then increase price to achieve at least minimum capacity value 332, and if customer did not accept the accepted price 335, eliminate the associated fixed overhead expenses 340.

As illustrated in FIGS. 4, and 6, yet another embodiment may include a computer-readable medium which may further include computer-executable instructions, wherein the capacity value analysis 150 provides profitable growth of the products and services after determining the capacity value analysis 150 by receiving the input of the data of product classifications with highest capacity value 402; target sales and marketing efforts to highest capacity value products 404; request for quote for targeted products 406, increase capacity value expectation as capacity is consumed 408 and the computer processor 630 determines: if product was not awarded 410, 411 repeat the steps of receiving the input of the data of target highest capacity value products 404; request for quote 406, through increase capacity value expectation as capacity is consumed 408; if product was awarded 410, 413 determine if capacity is available 420, and if capacity is available 423, manufacture product with free capacity 440 minimizing capital investments until capacity value exceeds target 450, and if capacity is not available 421, increasing prices on lower capacity value products until customer does not accept price 424, 426, 427, then use free capacity for higher value opportunities 430 and manufacture product with free capacity 440 minimizing capital investments until capacity value exceeds target 450.

As illustrated in FIGS. 5 and 6, still another embodiment may include a computer-readable medium which may further include computer-executable instructions, wherein the capacity value analysis 150 provides a metric for profit optimization initiatives by receiving the input of the data of capacity value improvement initiatives 510 by designing for manufacturability 512, and increasing throughput and reducing scrap 516, focus process improvement efforts on the constraint 514, and increasing throughput and reducing scrap 516; improving customer perceived value 522 and converting perceived value and service into higher prices 526; value engineering into products 524 and converting perceived value and service into higher margins 526 and the computer processor 630: evaluates initiatives based on change in capacity value 530, eliminates operating variances 540, reducing fixed overhead spending 550, increasing EBITDA 560, and increasing business value by reducing capital employed and debt service 570.

Applications of capacity value analysis:

Job Shop Approach: Specifically, most manufacturing software is job cost based, meaning a customer order is received, a work order is opened, and expenses are applied to the job. When the job is completed, management has the opportunity to look into a “rear view mirror” to evaluate past performance. There are other inherent flaws with the job shop approach, most notably too many transactions having too little value. When multiple processes are required to complete a product, a work order is opened for each incremental process. Although intuitively it may seem necessary to evaluate performance in each process, it is a distraction to the real objectives, improve finished goods throughput and on-time delivery. However, the lean approach focuses on the entirety of all processes required to manufacture a finished product, rather than individual processes. The lean approach will be synonymous with the term focus factories. Focus factories have dedicated resources and manufacture in a continuous flow to optimize manufacturing efficiency. Focus factories require less headcount than job shops and the constraint is visible making capital expenditures easier to justify. Likewise, the lean approach eliminates making unnecessary capital expenditures for incremental processes where there may be no return. Adapting highly flexible software to a lean manufacturing environment is difficult. Existing software requires too many transactions, they are too complex to setup, and lastly, do not have plan for profit capabilities. Since profit is constantly being eroded by unplanned waste, the primary feature of any software should be to identify and measure waste.

Quoting: In addition, the inability to compare how a product was quoted with how it is produced is a software flaw. The disconnect ranges from sales forecasts that do not materialize, to shipping expectations that were not planned, all of which are typically lost once the standard cost is loaded into the system with few maintaining the quote detail to insure customers uphold their commitment. Material Planning: When a company receives a Request for Quote, the customer is often overly optimistic regarding the annual demand in hopes of getting a better price. When this occurs, raw materials are quoted based on higher demand and purchasing typically commits to larger quantities and fewer releases. The results are most likely higher inventory and obsolescence at what was believed to be a lower purchase price. As a result, the company will likely experience reduced profit without sufficient information to diagnose the problem. Procurement: Material Resource Planning, or MRP, is a widely used approach to drive procurement activities. Although MRP is fundamentally the correct tool, the user must constantly expedite and/or de-expedite materials when customer orders change, schedules change, or supplier lead-time is not honored. To avoid administrative hassles, excess safety stock is typically added to avoid production interruptions. To further increase exposure, minimum order quantities often exceed the requirements of a customer release. The potential for obsolete inventory could be minimized, if not eliminated, if the potential for obsolescence was addressed when a product was quoted. Production Scheduling: Production scheduling is often a reaction to customer orders and the Master Scheduler can be the most powerful person in a company. Depending on his/her discipline, a Master Scheduler may favor either manufacturing efficiency or on-time delivery, but few will serve both. To make matters worse, commitments made by customers during the quoting process are not normally maintained in the customer data base. Therefore, if customers do not honor their commitments it will result in unfavorable variances that erode the standard contribution margin. GAAP versus Managerial Accounting: Most software adheres to Generally Accepted Accounting Practices, or GAAP. As an example, GAAP requires that finished products be burdened with fixed overhead. This approach is necessary for determining income tax liabilities but it is not good for decision making Contribution Margin Analysis omits fixed overhead to evaluate contribution margin as a percentage of the selling price. The fallacy is that a higher contribution margin percentage does not necessarily generate the higher return on capacity.

Capacity Value Analysis, or contribution margin per capacity hour:

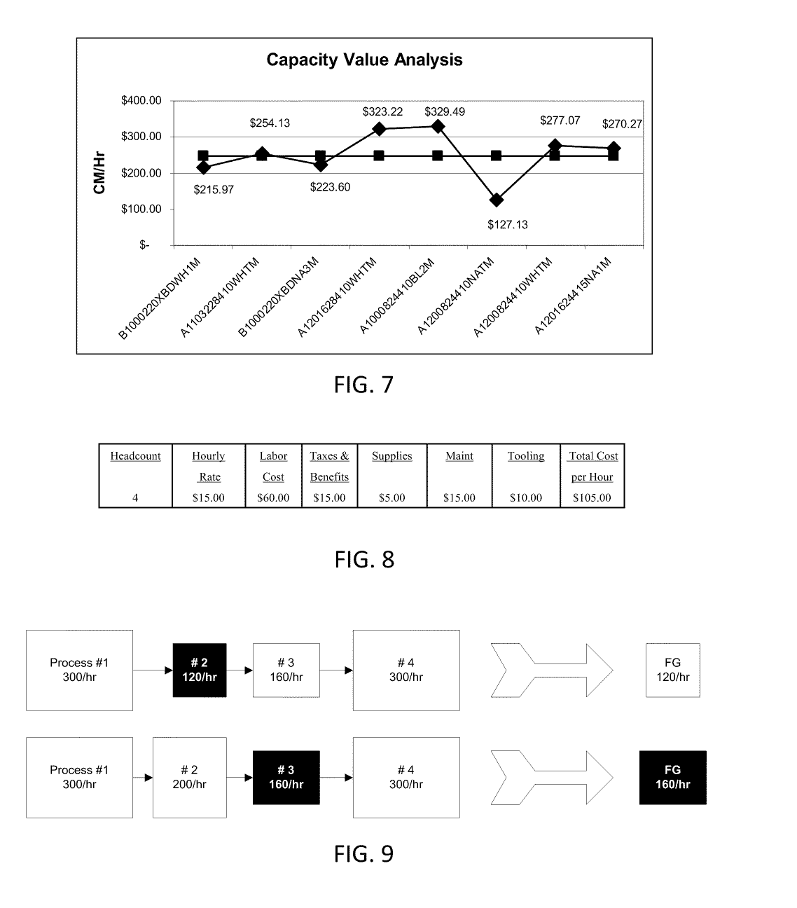

The most common quoting approach is to assign cost to processes, including fixed overhead, and to divide by a throughput rate to establish the standard cost. Materials are added, typically with a markup, and the total cost may be marked up by a profit percentage. If a company has excess capacity, the profit percentage is often lowered to be more competitive. In extreme circumstances products may be quoted as incremental business, meaning fixed overhead is excluded from the quote. A common argument is fixed overhead was covered by other products. Managerial accountants recognized that fixed overhead allocations may lead to bad decision-making Although not GAAP compliant, fixed overhead was eliminated from the product cost to determine the Contribution Margin of a product. Contribution margin pays fixed overhead expenses and the excess, if any, drops to the operating income line. Products may be further evaluated based on the contribution margin percentage, known as Contribution Margin Analysis. Products having the highest contribution margin percentage were considered the most lucrative. Although Contribution Margin Analysis is a managerial accounting breakthrough, it does not adequately value the profitability of a product. Products that generate the most contribution margin, or have the highest contribution margin percentage, may consume more capacity during manufacturing than a product with a lower percentage. Capacity is a commodity and it must be sold for the highest value. Otherwise, capacity may be depleted before sufficient contribution margin is generated. The important question is how much contribution margin does a product generate when a capacity hour is consumed? Since capacity is a limited resource, it requires a capital investment, and it justifies support spending, the objective must be to generate the highest contribution margin per capacity hour. The calculation seems as simple as dividing contribution margin by standard hours to determine contribution margin per capacity hour. This assumption would be correct if the contribution margin and standard hours accurately reflected the customer's expectations. Embodiments of the invention may include three of the more overlooked variables of a standards calculation, sales forecast, shipping frequency, and product specific setup time. If properly determined, contribution margin per capacity hour becomes a metric to cherry-pick the most lucrative opportunities and identify pricing disparities between similar products. The graph below illustrates how Capacity Values of similar products may vary significantly. Pursuing sales dollars over contribution margin, more often than not, leads to financial ruin. Many in the past may have chosen sales over margin, had excessive debt loads from capital equipment, and were overstaffed to support complicated business processes. Capacity Value Analysis is used to identify the most lucrative opportunities, liquidate excess assets, and right-size the company based on profitable demand. The graph in FIG. 7 illustrates that eight similar products have a Capacity Value range of $202/hour. If manufacturing operates three shifts per day, the Capacity Value range represents $1.2 million in contribution margin annually.

Capacity Value Analysis is designed to overcome tendencies that can lead to reduced profit and cash flow. Since most companies are sales-driven and seldom see an opportunity they don't like, it is not uncommon to underestimate cost in favor of a more competitive price. A target price often becomes the most important customer expectation and there is a common belief, if the competitor can do it, so can we. In reality, all it takes is one, unsophisticated competitor to drive down market prices to the point there is little, or no profit. The market may set the price but Capacity Value Analysis identifies the most lucrative markets. It starts with customer expectations and ends with a price. An annual forecast or a forecast in units per year, seasonality of releases, frequency of releases, and quality expectations factor into satisfying the customer. Knowing exactly what the customer expects of a supplier is critical when making the transition from either a sales driven or manufacturing driven company, to one that is profit driven and accomplishes both. Contribution margin is only recognized when a product is saleable therefore incremental processes, or work-in-process, does not generate contribution margin. Wherein multiple processes may be required to manufacture a finish product therefore capacity is the entirety of the processes. Whereas contribution margin is realized when the entirety of processes, hereby called capacity, produces a finished product. Capacity Value Analysis chooses to value capacity on an hourly basis, hence contribution margin per capacity hour. Accordingly, Capacity Value Analysis quantifies lean manufacturing principles. The Capacity Value Analysis approach begins with focus factories, a lean manufacturing term applied to the entirety of processes that manufacture a finished product. A focus factory consists of dedicated equipment that processes in a one piece, continuous flow. Products requiring the same, or at least most of the same processes may be assigned to the same focus factory but there are other variables to consider. Nonetheless, when a product is assigned to a focus factory it remains there so that capacity can be planned accurately. Focus factories have several benefits that outweigh the loss of flexibility and potentially under-utilized equipment. Focus factories require less headcount, they are easier to schedule, there is little, or no work-in-process inventory, and quality and delivery are better than batch and queue manufacturing. Advanced planning, although rigid and often difficult, does simplify manufacturing and it is essential if all the benefits of Capacity Value Analysis are to be realized. Most variable manufacturing expenses are time sensitive therefore they are incurred regardless of productivity. Examples of time driven expenses include direct labor, taxes and benefits, operating supplies, and maintenance. The hourly spending budget for a focus factory, hereafter referred to as its cost of capacity, weighs prominently in standard cost calculations. Indirect labor, such as material handling, maintenance and quality are considered hourly support and are often shared by more than one focus factory. If so, these associates would become part of the business unit fixed overhead budget. A focus factory budget as shown in FIG. 8 is considered time sensitive which means the expenses are incurred during changeovers, downtime, as well as production.

Standard Run Quantity: The standard run quantity is the annual sales forecast divided by the planned production runs, or setups per year. Inasmuch as possible, shipments would be made on the same frequency they are manufactured, avoiding unnecessary inventory and/or late shipments. Parts per Year/Setups per Year=Parts per Setup (or Standard Run Quantity)

Throughput at Constraint: Although it would be ideal if each process in a focus factory had the same throughput rate, it may not realistic. Therefore, the throughput rate that determines standard cost is based on the slowest process, or constraint. The process constraint for each product is identified within the Capacity Value Analysis. If the cycle time changes, the standard cost and Capacity Value also changes which may move the constraint to another process. Improvements made to non-constraint processes will not increase throughput or Capacity Value and tend to be a waste of time and capital. FIG. 9 depicts a constraint and the result of an improvement of the constraint. Process 2 was the constraint which has a throughput rate of 120 units per hour. A process improvement increased the throughput in process 2 moving the constraint to process 3, gaining 40 units per hour.

Capacity Hours: Capacity is consumed during changeovers and production. Establishing an accurate throughput rate and changeover time may be the single most critical components of standard cost and Capacity Value Analysis.

((Parts per Yr/Parts per Hr)+(Change Hrs per Setup×Setups per Yr))=Capacity Hrs per Yr

(Production Hrs per Yr+Changeover Hrs per Yr)=Capacity Hrs per Yr

Standard Cost: The hourly cost of capacity for the appropriate focus factory is multiplied times the capacity hours per year and then divided by the annual forecast to determine the standard cost per part.

((Cost of Capacity×Capacity Hrs per Yr)/Parts per Yr)=Standard Variable Cost per Part

Materials: Raw and packaging materials are consumed when finished products are manufactured therefore these costs should be included in the bill of materials. The standard purchase price of these items should include freight. The material cost of a product would be based on usage, the standard purchase price, and an allowance for scrap.

Standard Variable Cost per Part+Standard Material Cost per Part=Standard Direct Cost per Part

Capacity Value Analysis: Capacity Value (CV) is contribution margin per capacity hour 150 determined as follows:

(((Selling Price−Standard Direct Cost per Part)×Parts per Yr)/Capacity Hrs per Yr)=CV

(Contribution Margin per Yr/Capacity Hrs per Yr)=CV

Capacity Value Pricing: After entering the pertinent data for a new opportunity, a default price is established based on the minimum contribution margin (Min CM) per hour, or Capacity Value. There is a data field for additional contribution margin (Add CM) per hour that converts into a new selling price as well as capacity utilization information for the entire focus factory. Capacity Value Analysis reminds management that capacity is a limited resource that should increase in value as it is consumed, or utilized during the manufacturing process.

(((Min CM per Hr+Add CM per Hr)×Capacity Hrs per Lot)/Qty per Lot)=CM per Part

(CM per Part+Standard Direct Cost per Part)=Selling Price per Part

Capacity Value Analysis Applications:

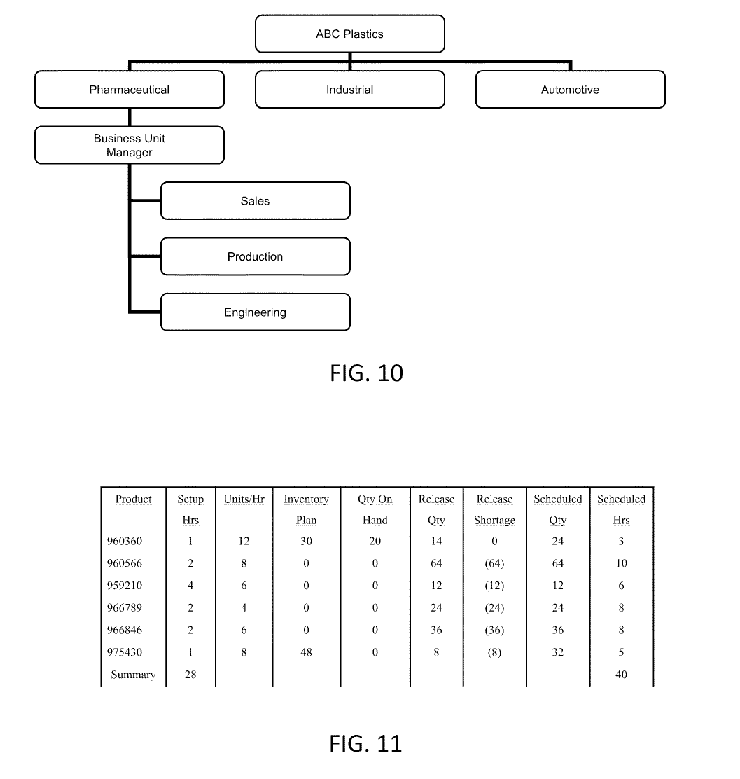

Companies tend to grow in a path of least resistance. Over time, it is not unusual to lose focus and add management to compensate. The profit optimization system provides a means to refocus the management team into self-sufficient business units. Each business unit has its own organization structure, a fixed overhead budget, and at least one or more focus factories. When dividing a company into business units consider the challenges and how they can best be accomplished. With the least spending, the management team must sell free capacity, increase capacity value, and eliminate operating variances. Inasmuch as possible, the market and customers should be the same to take advantage of synergies. A business unit is ultimately evaluated by the Net Contribution Margin it generates. FIG. 10 illustrates three business units created that focus on three different markets. Each business unit staff includes sales, engineering, and operations to accomplish the profit and cash flow objectives. A goal is to manufacture products the same way they were quoted avoiding unnecessary variances that erode contribution margin. Customer expectations, as well as customer commitments, must be respected throughout the relationship. The profit optimization system may archive pertinent information relating to the Supplier/Customer Partnership.

Order fulfillment Process:

Customer Lead-Time: An industry lead-time, or the time from receipt of a customer order to delivery, is established by the most aggressive supplier. Using the profit optimization system as a planning tool should make its users industry leaders. Customer responsiveness improves customer perceived value, and customer perceived value increases Capacity Value. Products should be manufactured on the same frequency as the customer lead-time. Changeovers deplete valuable capacity therefore every effort must be taken to reduce changeover time. The capacity planning tool within the profit optimization system enables the user to determine the shortest customer lead-time by changing the manufacturing frequency. As the manufacturing frequency, or lead-time, is shortened, the higher capacity requirement is compared to planned capacity. Sales Forecast: A customer's sales forecast may be the least accurate information affecting Production and Inventory Control. It is not uncommon for customers to inflate the forecast, especially on new products, to insure the lowest price. If actual sales are lower than forecast, the impact of changeover time is higher which results in variances. As changeover time is reduced, the impact that fluctuating sales have on variances may be negligible. The profit optimization system focuses on the relationship between sales and forecast and standard and actual changeover time. Economical Run Sequence: Reacting to customer orders by putting tooling in the next open machine increases changeover time. Although responding to a customer need is important, changeover time is affected by the product previously manufactured in the machine. The profit optimization system minimizes the impact of changeovers by establishing an economical run sequence for every product manufactured in a focus factory. Intuitively, it may seem that a rigid schedule impairs customer service but if the customer knows when a product will be manufactured responsiveness can actually improve. Master Production Schedule: A Master Production Schedule is automatically generated based on customer approved scheduling rules. A few of the scheduling rules are include: Products are assigned to focus factories based on family, tooling, and/or materials; Products will be scheduled in an economical run sequence to minimize setup time; Customer lead-time is the same as the manufacturing frequency; Orders less than a minimum run quantity may skip a cycle; Products are predominately made to order; and Excess capacity will be used to make to plan. A Master Production Schedule improves the accuracy of production and shipping dates. If necessary, the automatically generated schedule can be overridden but efficiency may be compromised. Standard Throughput Rate: The throughput rate is based on the cycle time at the constraint process. To establish the most accurate standard, a new product should go through a Production Part Approval Process (PPAP). The following should be determined during a PPAP: Number of conforming parts produced in an hour; Scrap based on the amount of nonconforming parts during run at rate; and an efficiency standard for unplanned downtime. The PPAP process integrates process capability and machine capability into the standard. Level Load Scheduling: Reacting to inconsistent customer releases without uncontrollably increasing inventory or incurring excessive overtime expenses is an ongoing scheduling challenge. To minimize associated variances, the profit optimization system employs level load principles to level customer demand. Customer releases are scheduled first, while remaining capacity, if any, automatically schedules inventory plan shortages. If releases exceed capacity, products are shipped from the inventory plan, if available. The schedule is automatically generated base on the profit optimization system rules of profitability. See the profit optimization system Master Production Schedule depicted in FIG. 11 illustrating that actual customer demand is less than planned capacity of 40 hours therefore the schedule was automatically updated to fill shortages to the inventory plan.

Inventory Planning:

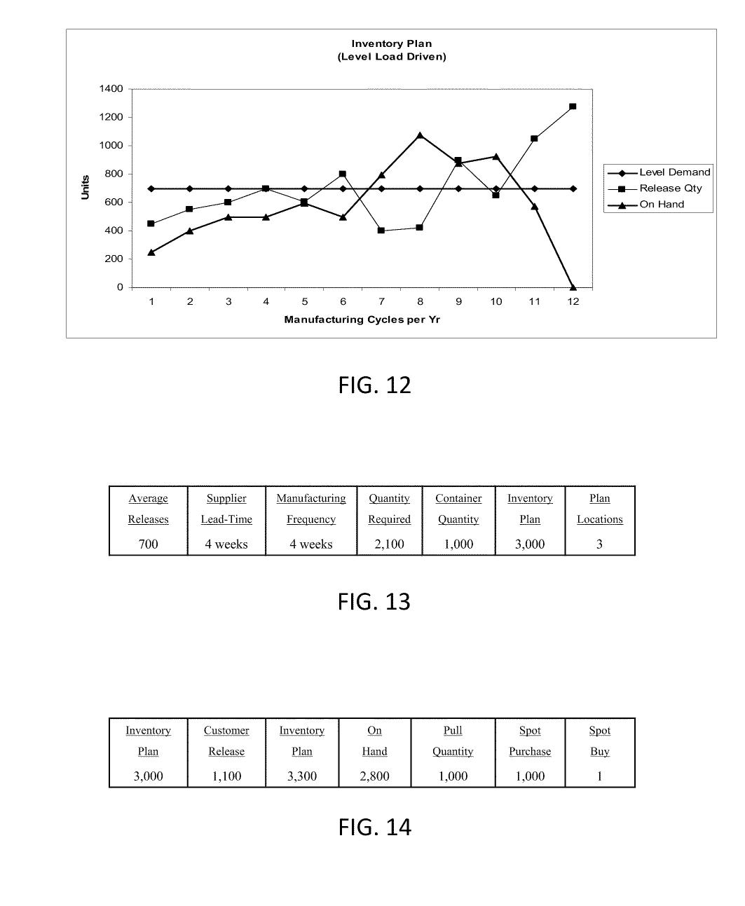

Inventory planning may be driven by a sales forecast, actual customer orders, or a combination of the two, which means orders consume the forecast. Material Resource Planning (MRP) is the methodology used to plan inventory and, if managed properly, can be effective. However, MRP requires a significant amount of expediting and de-expediting to react to customer changes, which increases the probability of high inventory and obsolescence. The profit optimization system utilizes a pull system so that inventory is available in advance of most customer releases. Having inventory available does not necessarily mean higher inventory. Supplier lead-times have a greater affect on inventory levels than the procurement method. The profit optimization system approach emphasizes lead-time, minimum order quantities, as well as price. Finished Product Plan: Finished products are mathematically classified as A, B, or C during the quoting process. Below is a description of each classification: “A” Products—high volume products with relatively consistent customer releases. They may ship more often than manufactured, forcing an inventory plan. The carrying cost is likely offset by improved labor utilization as it accommodates level loading the production schedule. “B” Products—moderate, to high volume, with less consistent releases but most likely manufactured every cycle. Shipments are made to customers within a few days after being produced therefore eliminating inventory. “C” Products—low volume products with infrequent releases. These products are difficult to plan, complicate scheduling, and are the most likely to have unique raw materials. Accordingly, raw materials are purchased to customer orders and the shipping lead-time is dictated by the unique raw material lead-time. Inventory plans are based on forecasted monthly releases and a level load production schedule. The graph shown in FIG. 12 illustrates a capacity plan based on 700 units per cycle although the actual customer releases are erratic. If the production schedule was level loaded the maximum inventory level, or plan, would be 1075. Warehouse space must accommodate the entire inventory plan, even though it will only be full when capacity is available to make to plan. Ideally, the warehouse layout will be in production sequence by focus factory to support visual factory concepts. Raw Material Plan: To improve customer responsiveness, inventory should be planned in advance of a customer release. The inventory plan is based on a forecasted material requirement times the supplier lead-time, divided by the box quantity, rounded up. The inventory plan must have at least two containers. To lower the inventory plan, the manufacturing frequency must be reduced. The trade-off is wasted capacity caused by additional changeovers. The table in FIG. 13 shows how an inventory plan is established within the profit optimization system. The inventory plan in this illustration is 3,000 pieces, 900 higher than the quantity required therefore the 900 is safety stock. Following each manufacturing cycle, the supplier receives a release against a blanket purchase order for the amount that was used. If the requirement for the next production run, based on actual orders, exceeds the inventory plan, the profit optimization system adds a spot buy quantity to the release. FIG. 14 illustrates a normal release, or pull quantity, would have been one container but the inventory plan would not accommodate the customer release. The profit optimization system Material Release Report indicates an additional container would be needed. Work-In-Process: Work-in-process inventory, or WIP, is seldom recognized in a lean manufacturing environment WIP. An exception may be if the first process has a high throughput rate and supplies several down line processes. If so, the profit optimization system provides a means to establish an inventory plan for WIP.

METRICS:

The profit optimization system Income Statement provides a high level view of the company's financial performance while other reports detail performance by focus factory. The reports support the profit optimization system strategy to: 1) increase standard Capacity Value, 2) eliminate variances, 3) reduce fixed overhead spending, and 4) optimize cash flow.

Income Statement Template:

Sales and Cost of Goods: The Chart of Accounts may be customized by the user but the

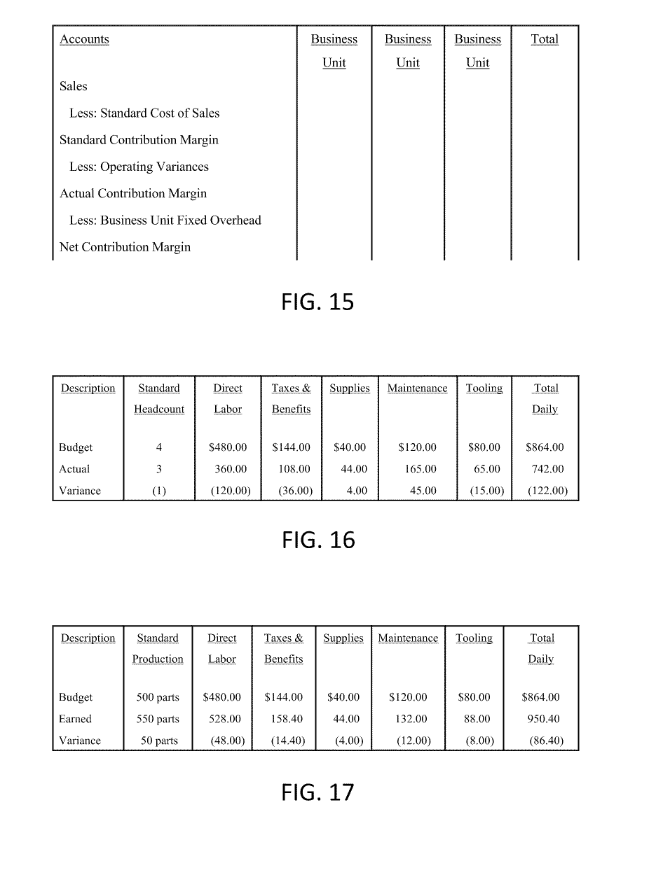

Income Statement template is standardized within the profit optimization system. Cost accounts in the quote module, are the same as the standard cost of goods and variances accounts in the Income Statement. The Income Statement template, without the detail, is shown in FIG. 15 where the profit optimization system Income Statement template is formatted to identify waste within the operation and to give ownership to those assigned to business units. The Standard Cost of Goods would ordinarily include materials, direct labor, operating supplies and other variable expenses. Operating variances would be expanded to include the same detail. Business Unit Budget: Business unit budgets will be as detailed as necessary to effectively control spending. The profit optimization system objective is to divide the company into smaller, more manageable businesses. In so doing, each business unit will pursue the most profitable business opportunities, operate more efficiently, and minimize the support staff and other fixed overhead spending to accomplish the objectives. Other Fixed Overhead Budget: Other fixed overhead consists of spending not directly assigned to business units. For example, a business unit may not justify an accounting department. Rent and insurance may not be reduced if a business unit is eliminated. It would be futile to burden the business unit with an expense they do not control. Shared expenses would be assigned to a shared resource, such as accounting, to budget and control. These expenses would be paid from business unit contribution margin. EBITDA: Earnings, Before Interest, Taxes, Depreciation and Amortization (EBITDA) is considered free cash from operations. The Income Statement template recognizes EBITDA because it is a common metric for valuing the business and it is the starting point of a cash flow analysis. EBITDA pays debt service, including interest payments on lines of credit, and income taxes. Cash flow projections are impacted by the age of accounts receivable and payable, and the change in inventory.

Variances:

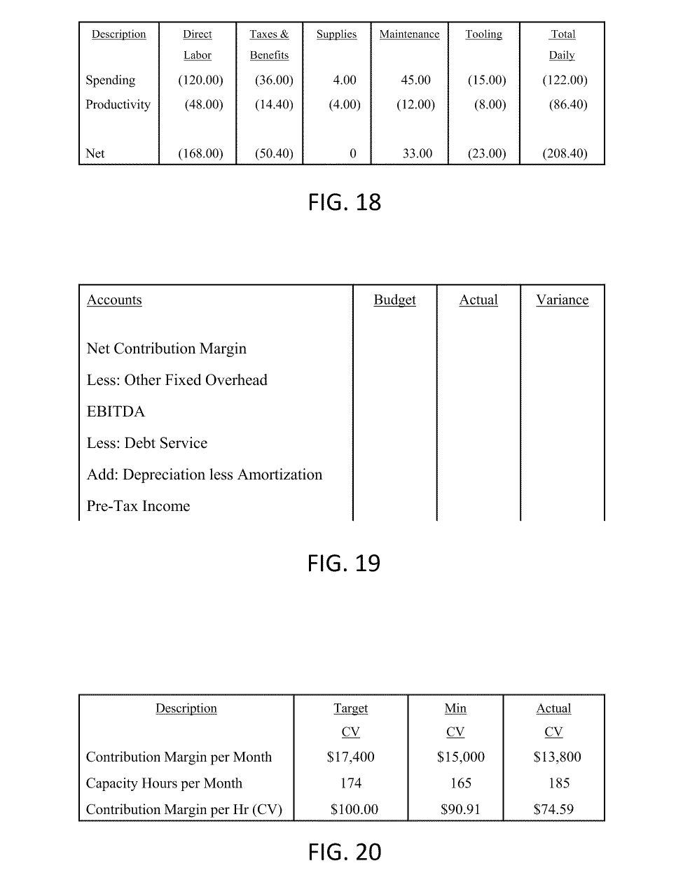

The profit optimization system uniquely integrates Activity Based Management and Process Cost principles to optimize profit and cash flow. ABM proponents suggest spending alone is the key to profitability while process cost accountants contend spending is justified by productivity. The profit optimization system integrates both principles because spending and productivity are inseparably linked. Spending Variances: Within the profit optimization system all expenditures are charged to a cost account through payroll, purchase orders, or disbursements. The difference between actual spending and the budget is a spending variance that emphasizes the importance of doing more, with less. Although it is not unusual to provide budget variances for fixed overhead, the profit optimization system may be the only software that tracks spending variances by focus factory. The table in FIG. 16 illustrates a focus factory under spending by $122.00 as compared to a $864 per shift budget. The spending variance is not impacted by productivity. Productivity Variances: In addition to a spending variance, the profit optimization system captures a productivity, or efficiency, variance. The productivity variance compares earned dollar from production with the spending budget used in the standard cost calculation. The chart in FIG. 17 shows a productivity variance wherein the focus factory produced 50 more parts than standard therefore earning $86.40 more than the budget. Operating Variance: The operating variance is the net effect of spending and productivity variances and will become an adjustment to Standard Contribution Margin. Most manufacturing software provides an operating variance, either through a process or job cost module. An operating variance identifies gains, or losses, to standard cost but does not indicate if the gain or loss was the result of spending or productivity. The net effect of the spending and productivity variances, as shown in FIG. 18, is a favorable $208.40, meaning actual contribution margin is $208.40 higher than the Standard Contribution Margin. Purchase Price Variances: A purchase price variance (PPV) is the difference between the standard and actual delivered price of an inventory item. The profit optimization system recognizes inventory when it is received and PPV when the invoice is posted to accounts payable. Like operating variances, PPV is an adjustment to Standard Contribution Margin in the Income Statement. The standard cost of inventory and customer prices should change at the same time to insure the variance is an unplanned adjustment to planned margin. Scrap and Shrink: The profit optimization system captures scrap and shrink separately to more effectively identify the root cause. A scrap factor is established for each product so it can be captured at standard. Actual scrap is compared to the standard to identify the scrap variance. Shrink is the difference between the perpetual inventory and the cycle count as depicted in FIG. 19 where the profit optimization system Income Statement template includes all variances that affect a company's profitability.

Capacity Value Analysis:

Minimum and target Capacity Values are established for each focus factory based on the perceived market value of the products. An ongoing comparison between target and actual Capacity Value reinforces the strategy to price higher as capacity is depleted. This approach improves profit and cash to target levels before spending capital on additional capacity. FIG. 20 depicts that as a result of unfavorable variances and inefficiency the focus factory generated $13,800 in contribution margin for the month while working 20 hours overtime. As a result, the CV was $16.32/hr less than standard and $25.41/hr less than target.

What is claimed is:

1. A method for providing profit optimization of products and services comprising the steps of:
determining an economical run sequence to minimize setup time;
determining a forecast in units per year;
determining a number of planned production runs per year;
determining a standard run quantity by dividing the forecast in units per year by the number of planned production runs per year;
determining a throughput rate at a constraint;
determining a production hours by dividing the standard run quantity by the throughput rate of the constraint;
determining a setup time in hours per standard run quantity;
determining a total capacity hours per standard run quantity by adding the setup time in hours per standard run quantity with the production hours;
determining an hourly cost of capacity budget;
determining a total variable cost per standard run quantity by multiplying the total capacity hours per standard run quantity times the hourly cost of capacity budget;
determining a standard variable cost per unit by dividing the total variable cost per standard run quantity by the standard run quantity;
determining a standard material cost per unit;
determining a standard direct cost per unit by adding the standard variable cost per unit and the standard material cost per unit;
determining expenses paid to a supplier;
determining a selling price of a product per unit;
determining a net selling price per unit by subtracting the expenses paid to the supplier from the selling price of the product per unit;
determining the contribution margin per unit by subtracting the standard direct cost per unit from the net selling price per unit;
determining a contribution margin per year by multiplying the contribution margin per unit times the forecast in units per year; and
determining a capacity value analysis by dividing the contribution margin per year by the product of the total capacity hours per standard run quantity times the number of planned production runs per year wherein the capacity value analysis aids in determining the maximum profitability of a company's products and services by concentration on the company's products and services that are the most profitable.

2. The method for providing profit optimization of products and services as set forth in claim 1 wherein to minimize setup time the economical run sequence, the throughput rate at the constraint, and the setup time in hours per standard run quantity is determined with the additional steps of:
determining a process map per finished product;
determining a grouping for finished products based on similar processes based on the process map per finished product;
determining a layout of equipment and processes to manufacture in a one-piece flow based on the group finished products based on similar processes;
determining assignment of finished products to a focus factory for manufacture in a one-piece flow; and
determining a standard based on the throughput rate at the constraint by manufacturing in a one-piece flow.

3. The method for providing profit optimization of products and services as set forth in claim 1 wherein after the step of determining a capacity value analysis, the capacity value analysis provides product rationalization with the additional steps of:
dividing the products by classifications including: type of industry, customer, geographic location, type of product, and type of raw material;
determining an upper capacity value, a lower capacity value, and a mean capacity value for the classification;
analyzing each product within the classification; if capacity value is not greater than zero dollars then jettison products with negative capacity value and eliminate the associated fixed overhead expenses;
if capacity value is greater than zero dollars and if annual contribution margin is greater than related fixed overhead then continue manufacturing the product;
if capacity value is greater than zero dollars, and if the annual contribution margin related fixed overhead is not greater than the related fixed overhead, then increase price to achieve at least min capacity value, and if customer accepted price, continue manufacturing the product; and
if capacity value is greater than zero dollars, and if the annual contribution margin is not greater than the related fixed overhead, then increase price to achieve at least minimum capacity value, and if customer did not accept the accepted price, eliminate the associated fixed overhead expenses.

4. The method for providing profit optimization of products and services as set forth in claim 1 wherein after the step of determining a capacity value analysis, the capacity value analysis provides profitable growth with the additional steps of:
determining product classifications with highest capacity value;
determining target sales and marketing efforts to highest capacity value products;
receiving a request for quote for targeted products;
increasing capacity value expectation as capacity is consumed;
if quote was not awarded repeat steps of determining target sales and marketing efforts through increasing capacity value expectation; and
if quote was awarded determining if capacity is available,
if capacity is available, manufacturing product with free capacity avoiding capital investments until capacity value exceeds target, and
if capacity is not available, increasing prices on lower capacity value products until customer does not accept price, then use free capacity to higher value opportunities and manufacturing product with free capacity minimizing capital investments until capacity value exceeds target.

5. The method for providing profit optimization of products and services as set forth in claim 1 wherein after the step of determining a capacity value analysis, the capacity value analysis provides metric for profit optimization initiatives with the additional steps of:
establishing capacity value improvement initiatives by:
designing for manufacturability and increasing throughput and reducing scrap, focus process improvement efforts on the constraint and increasing throughput and reducing scrap,
improving customer perceived value and converting perceived value and service into higher prices,
value engineering into products and converting perceived value and service into higher prices;
evaluating initiatives based on change in capacity value;
eliminating operating variances that erode contribution margin, reducing fixed overhead spending;
increasing EBITDA; and
increasing business value by reducing capital employed and debt service.

6. A system for providing profit optimization of products and services comprising:
a memory storage device for storing data wherein data may be stored and retrieved;
an input device for receiving entry of data wherein data may be input into the system; a computer processor operationally connected with the input device and the memory storage device for determining capacity value analysis;
the input device receives data including: an economical run sequence to minimize setup time; a forecast in units per year; a number of planned production per year; a throughput rate at a constraint; a setup time in hours per standard run quantity; an hourly cost of capacity budget; a standard material cost per unit; expenses paid to a supplier; and a selling price of a product per unit; and
the computer processor determines: a standard run quantity by dividing the forecast in units per year by the number of planned production per year; a production hours by dividing the standard run quantity by the throughput rate at the constraint; the total capacity hours per standard run quantity by adding the setup time in hours per standard run quantity with the production hours; a total variable cost per standard run quantity by multiplying the total capacity hours per standard run quantity times the hourly cost of capacity budget; a standard variable cost per unit by dividing the total variable cost per standard run quantity by the standard run quantity; a standard direct cost per unit by adding the standard variable cost per unit and the standard material cost per unit; a net selling price per unit by subtracting the expenses paid to the supplier from the selling price of the product per unit; the contribution margin per unit by subtracting the standard direct cost per unit from the net selling price per unit; a contribution margin per year by multiplying the contribution margin per unit times the forecast in units per year; and the capacity value analysis wherein the contribution margin per year is divided by the product of the total capacity hours per standard run quantity times the number of planned production runs per year; and
an output device operationally connected with the computer processor, the output device for providing the capacity value analysis to aid in determining the maximum profitability of the company's products and services that are maximized by concentration on the company's products and services that are the most profitable based on the capacity value analysis.

7. The system as set forth in claim 6 wherein the computer processor further:
determines a process map per finished product;
determines a grouping for finished products based on similar processes based on the process map per finished product;
determines a layout of equipment and processes to manufacture in a one-piece flow based on the group finished products based on similar processes;
determines assignment of finished products to a focus factory; and
determines a standard based on the throughput rate at the constraint by manufacturing in a one-piece flow that is used for determining the economical run sequence, the throughput rate at the constraint, and the setup time in hours per standard run quantity.

8. The system as set forth in claim 6 wherein: the computer processor provides product rationalization after determining the capacity value analysis by:
the input device receives data including: type of industry, customer, geographic location, type of product, and type of raw material; and
the computer processor determines: an upper, lower, and mean capacity value for the classification; analyzing each product within the classification; if capacity value is not greater than zero dollars then the output device directs to jettison products with negative capacity value and eliminate the associated fixed overhead expenses;
if capacity value is greater than zero dollars and if annual contribution margin is greater than related fixed overhead then the output device directs to continue manufacturing the product;
if capacity value is greater than zero dollars, and if the annual contribution margin related fixed overhead is not greater than the related fixed overhead, then the output device directs to increase price to achieve at least min capacity value, and if customer accepted price, to continue manufacturing the product; and
if capacity value is greater than zero dollars, and if the annual contribution margin is not greater than the related fixed overhead, then the output device directs to increase price to achieve at least minimum capacity value, and if customer did not accept the accepted price, the output device directs to eliminate the associated fixed overhead expenses.

9. The system as set forth in claim 6 wherein:
the system provides profitable growth of the products and services after determining the capacity value analysis by the input device receiving the input of the data of product classifications with highest capacity value; target sales and marketing efforts to highest capacity value products; request for quote for targeted products, increase capacity value expectation as capacity is consumed and
the computer processor determines:
if quote was not awarded repeat the steps of receiving target highest capacity value products, request for quote, through increase capacity value expectation as capacity is consumed;
if quote was awarded determine if capacity is available, and
if capacity is available, manufacture product with free capacity minimizing capital investments until capacity value exceeds target, and
if capacity is not available, increasing prices on lower capacity value products until customer does not accept price, then use free capacity for higher value opportunities and manufacture product with free capacity minimizing capital investments until capacity value exceeds target.

10. The system as set forth in claim 6 wherein:
the system provides metric for profit optimization initiatives by the input device receiving the input of the data of profit optimization improvement initiatives by designing for manufacturability, and increasing throughput and reducing scrap; focus process improvement efforts on the constraint, and increasing throughput and reducing scrap; improving customer perceived value and converting perceived value and service into higher prices; value engineering into products and converting perceived value and service into higher prices; and the computer processor: evaluates initiatives based on change in capacity value, eliminating operating variances, reducing fixed overhead spending, increasing EBITDA, and increasing business value; and the output device provides changes in capacity value, operating variances that erode contribution margin, fixed overhead spending, EBITDA, and capital employed and debt service information.

11. A computer-readable medium having computer-executable instructions which when executed by a computer system cause the computer processor to perform operations that provide for profit optimization comprising:
receiving and storing data comprising: an economical run sequence to minimize setup time; a forecast in units per year; a number of planned production per year; a throughput rate at a constraint; a setup time in hours per standard run quantity; an hourly cost of capacity budget; a standard material cost per unit; expenses paid to a supplier; and a selling price of a product per unit; and
determine a capacity value analysis by determining:
a standard run quantity by dividing the forecast in units per year by the number of planned production per year; a production hours by dividing the standard run quantity by the throughput rate at the constraint; the total capacity hours per standard run quantity by adding the setup time in hours per standard run quantity with the production hours; a total variable cost per standard run quantity by multiplying the total capacity hours per standard run quantity times the hourly cost of capacity budget; a standard variable cost per unit by dividing the total variable cost per standard run quantity by the standard run quantity; a standard direct cost per unit by adding the standard variable cost per unit and the standard material cost per unit; a net selling price per unit by subtracting the expenses paid to the supplier from the selling price of the product per unit; the contribution margin per unit by subtracting the standard direct cost per unit from the net selling price per unit; a contribution margin per year by multiplying the contribution margin per unit times the forecast in units per year; and the capacity value analysis wherein the contribution margin per year is divided by the product of the total capacity hours per standard run quantity times the number of planned production runs per year wherein the capacity value analysis aids in determining the maximum profitability of a company's products and services by concentration on the company's products and services that are the most profitable.

12. The computer-readable medium of claim 11, wherein the computer-readable medium further provides computer-executable instructions wherein the capacity value analysis provides product rationalization by the computer processor performing the further steps of:
receiving and storing the input of the data of the products by classifications including: type of industry, customer, geographic location, type of product, and type of raw material;
determining an upper, lower, and mean capacity value for the classification and analyzing each product within the classification; if the capacity value is not greater than zero dollars then jettison products with negative capacity value and eliminate the associated fixed overhead expenses;
if capacity value is greater than zero dollars and if annual contribution margin is greater than related fixed overhead then continue manufacturing the product;
if capacity value is greater than zero dollars, and if the annual contribution margin related fixed overhead is not greater than the related fixed overhead, then the output device directs to increase price to achieve at least min capacity value, and if customer accepted price, continue manufacturing the product; and
if capacity value is greater than zero dollars, and if the annual contribution margin is not greater than the related fixed overhead, then the output device directs to increase price to achieve at least minimum capacity value, and if customer did not accept the accepted price, the output device directs to eliminate the associated fixed overhead expenses.

13. The computer-readable medium of claim 11, wherein the computer-readable medium further provides computer-executable instructions wherein the capacity value analysis provides profitable growth by the computer processor performing the further steps of: receiving and storing the input of the data of: target sales and marketing efforts to highest capacity value products; request for quote for targeted products, increase capacity value expectation as capacity is consumed and the computer processor determines:
if product was not awarded repeat the steps of receiving the target highest capacity value products; request for quote, through increase capacity value expectation as capacity is consumed;
if product was awarded determine if capacity is available, and if capacity is available, manufacture product with free capacity minimizing capital investments until capacity value exceeds target, and
if capacity is not available, increasing prices on lower capacity value products until customer does not accept price, then use free capacity for higher value opportunities and manufacture product with free capacity minimizing capital investments until capacity value exceeds target.

14. The computer-readable medium of claim 11, wherein the computer-readable medium further provides computer-executable instructions wherein the capacity value analysis provides a metric for profit optimization initiatives by the computer processor performing the further steps of: receiving and storing: the input of the data of profit optimization improvement initiatives by designing for manufacturability, and increasing throughput and reducing scrap, focus process improvement efforts on the constraint, and increasing throughput and reducing scrap; improving customer perceived value and converting perceived value and service into higher prices; value engineering into products and converting perceived value and service into higher prices and the computer processor: evaluates initiatives based on change in capacity value, eliminates operating variances, reducing fixed overhead spending, increasing EBITDA, and increasing business value; and the output device provides changes in capacity value, operating variances that erode contribution margin, fixed overhead spending, EBITDA, and capital employed and debt service information.

15. The computer-readable medium of claim 11, wherein the computer-readable medium further provides computer-executable instructions wherein the computer processor further performs operations comprising: determining a process map per finished product; determining a grouping for finished products based on similar processes based on the process map per finished product; determining a layout of equipment and processes to manufacture in a one-piece flow based on the group finished products based on similar processes; determining assignment of finished products to a focus factory; and determining a standard based on the throughput rate at the constraint by manufacturing in a one-piece flow that is used for determining the economical run sequence, the throughput rate at the constraint, and the setup time in hours per standard run quantity.
